(19) United States
(12) Patent Application Publication
(10) Pub. No.: US 2022/0243110 A1
(43) Pub. Date: Aug. 4, 2022

(54) Compositions Comprising Oligomerized Reaction Products and Methods for Downhole Use Thereof

(71) Applicant: ExxonMobil Chemical Patents Inc., Baytown, TX (US)

(72) Inventors: Larry L. Iaccino, Seabrook, TX (US); Joshua I. Cutler, Houston, TX (US)

(21) Appl. No.: 17/596,536

(22) PCT Filed: Jun. 17, 2020
(86) PCT No.: PCT/US2020/038123

§ 371 Date: Dec. 13, 2021

Related U.S. Application Data
(60) Provisional application No. 62/863,621, filed on Jun. 19, 2019.

(30) Foreign Application Priority Data
Aug. 13, 2019 (EP) 19191374.8

(51) Int. Cl. C09K 8/035; C10M 105/18

(52) U.S. Cl. CPC C09K 8/035; C09K 2208/34; C09K 2208/28; C10M 105/18

(57) ABSTRACT

Compositions for decreasing friction may comprise an optional carrier fluid, and one or more reaction products. The one or more reaction products may be formable from Component 1 and Component 2; and an acid and water combined therewith after one or more initial reaction products have formed. A, B and D are independently branched or unbranched, cyclic or acyclic, substituted or unsubstituted, saturated or unsaturated C₁-C₁₀₀ hydrocarbyl groups. Z is a nucleophilic group selected from OH, SH and NH₂, and X is a leaving group. Downhole methods may comprise introducing a wellbore fluid comprising the reaction product(s) into a subterranean formation.

This application claims the benefit of priority from U.S. Provisional Application No. 62/863,621 filed 19 Jun. 2019; and European Patent Application No. 19191374.8 filed 13 Aug. 2019.

### FIELD

The present disclosure relates to compositions suitable for reducing friction and, more specifically, compositions and methods suitable for reducing friction within a wellbore.

### BACKGROUND

Drilling operations within an earthen formation for promoting extraction of a natural resource or a related purpose generally utilize a fluid for removing cuttings from the wellbore, lubricating and cooling the drill bit, controlling formation pressures, and maintaining hole stability. The fluid used in conjunction with drilling a wellbore may be referred to as a “drilling mud” or “drilling fluid.” Fluids may also be used for other purposes downhole including cleaning, formation modification, completion, and the like. For the purposes of this disclosure, the term “wellbore fluid” refers to any fluid used in conjunction with creating, readying for use, and/or operating a wellbore. As such, illustrative wellbore fluids may include, for example, drilling fluids, completion fluids, cleanout fluids, and the like.

Excessive friction while drilling a wellbore can be problematic, particularly during horizontal drilling operations, in which both rotational and axial friction may be present. These two types of friction lead to torque losses and drag losses, respectively. During horizontal drilling operations, it can be difficult to keep the drill string from contacting the wellbore walls and thereby leading to high drag loss. Contact between the drill string and the horizontal wellbore walls can be particularly prevalent in extended reach drilling (ERD) operations, in which the horizontal section of the wellbore may extend several miles laterally from the entry point in an earthen formation. Regardless of type, excessive friction may lead to equipment damage and/or an inability to continue extending a wellbore to a desired length.

Various additives may be included in wellbore fluids, including drilling fluids, in order to reduce frictional losses therein. Liquid or solid friction reduction additives, or any combination thereof, may be used for this purpose. In addition, transitional friction reduction additives, which convert from a solid form to a liquid form when exposed to high-friction loci, may also be used, either alone or in combination with liquid and/or solid friction reduction additives.

Solid friction reduction additives often afford high stability and good friction reduction properties when the particle size is greater than that of the indigenous particles within a wellbore. At this particle size, however, solid friction reduction additives may be subject to extensive removal by wellbore screens configured for removing the indigenous particles from the wellbore fluid.

Liquid friction reduction additives may be desirable for use within a wellbore, since they are generally not retained by wellbore screens. An illustrative liquid friction reduction additive commonly used in the oilfield industry is ULTRALUBE II (Lubrizol, Inc.), which has allowed horizontal drilling of up to about 40,000 feet to be realized. Without being bound by theory or mechanism, liquid friction reduction additives are believed to function through adsorption onto a surface, such as the metal surface of a drill string, thereby decreasing the coefficient of friction. Since liquid friction reduction additives may also adsorb upon the indigenous solids in the wellbore, the liquid friction reduction additives are continually removed with the drill cuttings, thereby necessitating replacement as the wellbore is further extended. If the liquid friction reduction additive is costly, removal upon drill cuttings may be particularly problematic. As such, low-cost liquid friction reduction additives may be desirable. In addition, further improvements in liquid friction reduction technology would be welcomed to facilitate even more extended horizontal drilling operations and/or to address other situations in a wellbore in which excessive friction may become problematic. Improvement in liquid friction reduction technology may afford non-limiting benefits such as, for example, facilitating longer horizontal wellbore sections without expensive rig upgrades, reducing the time needed to drill extended substantially horizontal wellbore sections, accessing stranded reservoirs using existing infrastructure and/or accessing more oil reserves at a reduced cost, and/or facilitating certain extended reach drilling operations, such as those found in deepwater wells.

### SUMMARY

Described herein are compositions that may be effective for decreasing friction. The compositions comprise one or more reaction products that are formable from Component 1 and Component 2; Component 1 and Component 2′; Component 2′; Component 1, Component 2 and Component 2′; or any combination thereof

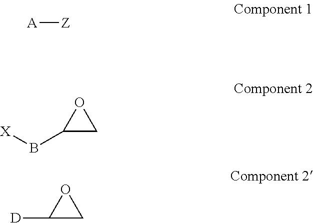

and an acid and water combined therewith, optionally after at least Component A has formed as an initial reaction product.

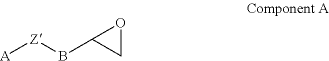

The acid is selected from the group consisting of a mineral acid, a sulfonic acid, a sulfinic acid, a phosphonic acid, a phosphinic acid, and any combination thereof. A, B and D are independently branched or unbranched, cyclic or acyclic, substituted or unsubstituted, saturated or unsaturated C₁-C₁₀₀ hydrocarbyl groups. Z is a nucleophilic group selected from the group consisting of OH, SH and NH₂. X is a leaving group displaceable by the nucleophilic group. If the one or more reaction products comprises Component A′, Component A″, or any combination thereof,

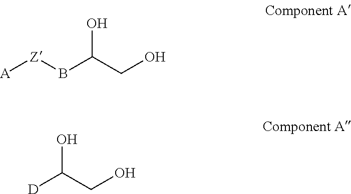

the one or more reaction products further comprises at least one additional oligomer differing from Component A′ and Component A″ and selected from the group consisting of at least one oligomer formable from Component A, at least one oligomer formable from Component A′, at least one oligomer formable from Component A″, at least one oligomer formable from Component 2, at least one oligomer formable from Component 2′, and any combination thereof. Z′ is selected from the group consisting of 0, S and NH. The skilled person will understand that Z′ is the deprotonated equivalent of Z; i.e. Z′ is O if Z is OH; Z′ is S if Z is SH; and Z′ is NH if Z is NH₂.

In particular embodiments, the one or more reaction products are formable from
a) reacting Component 1 and Component 2 as defined above in the presence of a base, thereby allowing the formation of one or more initial reaction products comprising at least Component A as described above; and
b) adding an acid and water to said one or more initial reaction products, wherein the acid is selected from the group consisting of a sulfonic acid, a sulfinic acid, a phosphonic acid, a phosphinic acid, and any combination thereof, thereby obtaining said one or more reaction products;
   wherein the one or more reaction products comprise Component B, Component C, or a combination thereof

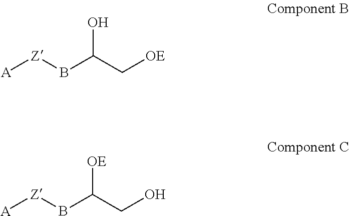

wherein E is —SO₂R¹, —SOR², —PR³O(OH), —POR⁴R⁵, wherein R¹, R², R³, R⁴, R⁵ independently are a branched or unbranched, cyclic or acyclic, substituted or unsubstituted, saturated or unsaturated C₁-C₁₀₀ hydrocarbyl group; and wherein the one or more reaction products optionally comprise one or more oligomers formable from Component A, an oligomer formable from Component B, an oligomer formable from Component B, an oligomer formable from Component C, or any combination thereof. The skilled person will understand that E is —SO₂R¹ if the acid is sulfonic acid (with formula R¹—S(═O)₂—OH), —SOR² if the acid is sulfinic acid (with formula R²—S(═O)OH), —PR³O(OH) if the acid is phosphonic acid (with formula R³—P(═O)(OH)₂), and —POR⁴R⁵ if the acid is phosphinic acid (with formula R⁴R⁵P(═O)(OH).

In particular embodiments, the one or more reaction products are formable from a reaction mixture comprising Component 2′ as defined above; water; and an acid selected from the group consisting of a sulfonic acid, a sulfinic acid, a phosphonic acid, a phosphinic acid, and any combination thereof; thereby obtaining said one or more reaction products; wherein the one or more reaction products comprise Component X, Component Y, or a combination thereof

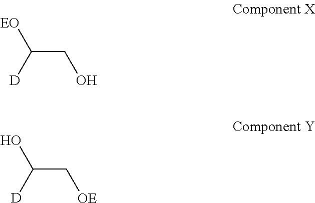

wherein E is —SO₂R¹, —SOR², —PR³O(OH), —POR⁴R⁵, wherein IV, R², R³, R⁴, R⁵ independently are a branched or unbranched, cyclic or acyclic, substituted or unsubstituted, saturated or unsaturated C₁-C₁₀₀ hydrocarbyl group. The skilled person will understand that E is —SO₂R¹ if the acid is sulfonic acid, —SOR² if the acid is sulfinic acid, —PR³O(OH) if the acid is phosphonic acid, and —POR⁴R⁵ if the acid is phosphinic acid.

In particular embodiments, the one or more reaction products are formable from
a) reacting Component 1 and Component 2 as defined above in the presence of a base, thereby allowing the formation of one or more initial reaction products comprising at least Component A as defined above; and
b) adding a mineral acid and water to said one or more initial reaction products; thereby obtaining said one or more reaction products, wherein the one or more reaction products optionally comprise Component A′ as defined above; and at least comprise one additional oligomer differing from Component A′ and selected from the group consisting of at least one oligomer formable from Component A, at least one oligomer formable from Component A′, at least one oligomer formable from Component 2, and any combination thereof.

In some embodiments, the present disclosure provides methods for formulating compositions that may be effective for decreasing friction. The methods comprise combining one or more reaction products contained in the compositions as described herein with a carrier fluid to form a composition having lubricant properties.

In some embodiments, the present disclosure provides downhole methods using a composition effective for decreasing friction. The methods comprise providing a wellbore fluid comprising a carrier fluid and one or more reaction products combined with the carrier fluid, and introducing the wellbore fluid into a wellbore penetrating a subterranean formation. The one or more reaction products are reaction products contained in the compositions described herein.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to one of ordinary skill in the art and having the benefit of this disclosure.

FIG. 1 depicts a schematic of the testing protocol used to determine coefficient of friction in the Examples described below.

FIGS. 2A and 2B show adsorption isotherms of the reaction products of Examples 2B and 2C, respectively, upon an iron surface.

### DETAILED DESCRIPTION

The present disclosure relates to compositions having lubricating properties and, more specifically, compositions and methods effective for decreasing friction within a wellbore and other locations. The present disclosure provides compositions having lubricating properties. In particular embodiments, the compositions comprise one or more reaction products, preferably including various oligomeric reaction products, formable from a reaction between a monofunctional and/or bifunctional epoxide compound and a nucleophile-bearing hydrocarbyl compound comprising one or more nucleophilic groups. Suitable nucleophilic groups within the nucleophile-bearing hydrocarbyl compound may include, for example, OH, SH, NH₂ or a deprotonated form thereof. In preferred embodiments, the nucleophilic group is OH or its deprotonated form. The deprotonated form may be generated in situ when reacting the monofunctional or bifunctional epoxide compound with the nucleophile-bearing hydrocarbyl compound comprising one or more nucleophilic groups.

The reaction between the nucleophile-bearing hydrocarbyl compound and the epoxide compound is typically performed in the presence of a base. Suitable bases include, but are not limited to sodium hydroxide, potassium hydroxide, lithium hydroxide, and calcium hydroxide. The base is preferably added in a molar excess with respect to the nucleophile-bearing hydrocarbyl compound, more preferably in a molar excess of at least 10%, for example a molar excess of about 50%.

In embodiments where Component 1 and Component 2 are combined, it will be understood that these two components will be reacted under conditions allowing for the formation of Component A as an initial reaction product. In particular embodiments, the components are reacted at a temperature above 50° C., or above 100° C., In further embodiments, the components are reacted at a temperature between 120° C. and 200° C., for example about 150° C.

The molar ratio of the amount of nucleophile-bearing hydrocarbyl compound and the amount of epoxide compound used for the reaction typically is between 5:1 and 1:5, preferably is between 2:1 and 1:2; for example about 1:1. In particular embodiments, no excess epoxide compound is added with respect to the nucleophile-bearing hydrocarbyl compound.

The reactions described herein are typically performed in solution. In particular embodiments, the solution may contain one or more solvents, and the solvents may form a multi-phase system. Indeed, in many cases, suitable solvents for Component 1 (i.e. wherein Component has a high solubility) will be poor solvents (i.e. providing low to very low solubility) for a base such as NaOH. In specific embodiments, the solution contains an aqueous phase (containing at least 50 wt % water, preferably at least 70 wt % water, and optionally also some organic solvents) and an organic-rich phase (containing more than 50 wt % of organic solvent, preferably at least 70 wt % organic solvent, but optionally also containing some water).

The bifunctional epoxide compound may bear a suitable leaving group that is displaceable by the nucleophilic group, such that an initial reaction product may form in which the hydrocarbyl group is coupled to the bifunctional epoxide compound by an O, S, or NH linkage; in case of a OH, SH, or NH₂ nucleophilic group, respectively. Some nucleophile-bearing hydrocarbyl compounds suitable for use in any embodiment of the present disclosure may comprise two nucleophilic groups, such as a diol or a diamine. Suitable leaving groups displaceable by a nucleophilic group in any embodiment of the present disclosure may include, but are not limited to, halides (e.g., chloride, bromide, or iodide) or halide equivalents, such as sulfonates (e.g., methanesulfonate, toluenesulfonate, trifluoromethanesulfonate, or the like). The initial reaction product may then proceed through additional reactions including, for example, acid hydrolysis to open the epoxide to a diol, nucleophilic opening of the epoxide with the nucleophile-bearing hydrocarbyl group, or various combinations of these reactions and others to form one or more compounds that may mitigate friction. For example, hydroxyl groups formed following epoxide hydrolysis and/or nucleophilic epoxide opening may serve as nucleophiles to promote further formation of higher oligomers. Optionally, the initial reaction product(s) may be isolated and/or purified before undergoing acid hydrolysis or undergoing further epoxide ring opening. In addition to or as an alternative to the coupling reaction described above, an initial reaction product may form through nucleophilic opening of the epoxide ring within the bifunctional epoxide compound.

Monofunctional epoxide compounds may undergo nucleophic opening in a similar manner to afford a similar range of products. As such, a reaction mixture comprising a nucleophile-bearing hydrocarbyl compound and a monofunctional and/or bifunctional epoxide compound may form a complex mixture of oligomeric products, wherein the complex mixture as a whole is effective for decreasing friction.

However, the present inventors have found that effective friction-reducing compounds can also be obtained via reacting a monofunctional epoxide compound with an acid selected from a sulfonic acid, a sulfinic acid, a phosphonic acid, a phosphinic acid, or combinations thereof. In such embodiments, the presence of a nucleophile-bearing hydrocarbyl compound is optional.

More detailed discussion of the reactions that a reaction mixture comprising a nucleophile-bearing hydrocarbyl compound and a monofunctional and/or bifunctional epoxide may undergo follows herein below.

Aside from their ability to decrease friction, the reaction products described herein may be advantageous from several additional standpoints. Many nucleophile-bearing hydrocarbyl compounds and monofunctional and/or bifunctional epoxide compounds are readily available and often inexpensive chemicals, and they may be coupled under straightforward reaction conditions to form the reaction products described herein. Monofunctional epoxide compounds, for example, may be prepared by oxidation of a linear alpha olefin, various chain lengths of which are readily available. Accordingly, the compositions described herein may be produced in bulk relatively inexpensively, which may make them well suited for use in high-volume applications, such as within a wellbore. Moreover, individual reaction products do not need to be separated from one another in order to realize the friction reduction properties described herein.

As mentioned above, an initial reaction product formed upon coupling the nucleophile-bearing hydrocarbyl compound to the bifunctional epoxide compound may undergo further hydrolytic epoxide opening in the presence of an acid. Monofunctional epoxide compounds may undergo similar hydrolytic epoxide ring opening. Alternately, nucleophilic opening of the epoxide ring may take place. Optionally, the acid addition may be conducted after isolating and/or purifying the initial reaction product(s). Otherwise, the acid may be added directly to the initial reaction mixture, such that the one or more reaction products are formed in a ‘one pot’ fashion. The initial reaction product or any ring-opened variant thereof may undergo a further reaction with either the nucleophile-bearing hydrocarbyl compound and/or the monofunctional and/or bifunctional epoxide compound to form a plurality of higher oligomers having a range of possible structures, exemplary members of which are discussed further below. The range of structures formed, including compounds having variable molecular weights and exhibiting considerable structural diversity, may facilitate strength and surface coverage during friction reduction applications. Because the reaction products formed according to the disclosure herein are non-ionic, they are not significantly impacted by salinity or dissolved ions within a wellbore fluid. Moreover, the reaction products disclosed herein exhibit good surface adsorption to facilitate their friction reduction performance.

In any embodiment, one or more acids are added in a sufficient amount and under conditions to allow for the epoxide ring opening. In particular embodiments, the ring opening reaction takes place at a pH below 3, preferably below 2. In particular embodiments, the epoxide ring opening via the addition of acid may be performed at a temperature of at least 20° C., at least 40° C., or at least 50° C. In specific embodiments, the ring opening reaction occurs at a temperature between 50° C. and 100° C., for example from 70° C. to 80° C.

Further adding to the available structural diversity afforded by the present disclosure, various families of oligomeric reaction products may be formed depending upon the type of acid used to promote opening of the epoxide. Mineral acids, for instance, lead to formation of a diol upon epoxide opening. Sulfonic acids, sulfinic acids, phosphonic acids, and phosphinic acids, in contrast, may lead to the corresponding sulfonate, sulfinate, phosphonate or phosphinate monoesters, respectively, wherein one carbon atom of the ring-opened epoxide bears a hydroxyl group and the other carbon atom is functionalized with the sulfonate, sulfinate, phosphonate or phosphinate monoester. Both isomeric monoesters may be formed upon epoxide opening. The free hydroxyl group may undergo further functionalization to promote formation of higher oligomers in a manner similar to that described above. The appended sulfonate, sulfinate, phosphonate or phosphinate monoester groups may be used to affect further tailoring of the properties of the reaction products disclosed herein. For example, the size of the hydrocarbyl group in the sulfonic, sulfinic, phosphonic or phosphinic acid may be varied to impact the hydrophobicity of the reaction products. Sulfonated reaction products, in particular, may afford greater surface adsorption in comparison to their non-sulfonated counterparts. Moreover, sulfonates also may, in turn, undergo subsequent nucleophilic displacement to provide further structural variation in the reaction products described herein. Despite their reactivity, sulfonated reaction products may exhibit compatibility with aqueous carrier fluids, including those found in various oilfield fluids, whereas sulfate- and phosphate-based materials may be unstable in aqueous carrier fluids. Further advantageously, sulfonated reaction products may afford superior friction reduction capabilities compared to their non-sulfonated counterparts.

All numerical values within the detailed description and the claims herein are modified by “about” or “approximately” with respect to the indicated value, and take into account experimental error and variations that would be expected by a person having ordinary skill in the art. Unless otherwise indicated, room temperature is about 25° C.

As used herein, the terms “well” and “wellbore” are used interchangeably and can include, without limitation, an oil, gas, or water production well, an injection well, or a geothermal well. As used herein, a “well” includes at least one wellbore. A wellbore can include vertical, inclined, and/or horizontal portions, and it can be straight, curved, or branched. As used herein, the term “wellbore” includes any cased portion, or any uncased, open-hole portion of the wellbore. A near-wellbore region is the subterranean material and rock of the subterranean formation surrounding the wellbore. As used herein, a “well” also includes the near-wellbore region. The near-wellbore region is generally considered to be the region within about 10 feet of the wellbore, although other distances both shorter and longer are also contemplated. As used herein, the terms “into a well,” “into a wellbore” or “into a subterranean formation” mean and include into any portion of the well, including into the wellbore or into the near-wellbore region via the wellbore.

A portion of a wellbore may be an open-hole or cased-hole. In an open-hole wellbore portion, a tubing or drill string may be placed into the wellbore. The tubing or drill string allows fluids to be circulated in the wellbore. In a cased-hole wellbore portion, a casing is placed and cemented into the wellbore, which can also contain a tubing or drill string. The space between two cylindrical shapes is called an annulus. Examples of an annulus include, but are not limited to: the space between the wellbore and the outside of a tubing or drill string in an open-hole wellbore; the space between the wellbore and the outside of a casing in a cased-hole wellbore; and the space between the inside of a casing and the outside of a tubing or drill string in a cased-hole wellbore.

For purposes of the present disclosure, the term “friction” refers to mechanical resistance, such as mechanical resistance associated with rubbing of a drill string with a cased-hole or an open-hole as the drill string or tubing is moved, withdrawn, advanced or rotated. Furthermore, friction also comprises the mechanical resistance of coiled tubing inside the cased-hole or the open-hole; introducing casing; introducing screens; introducing tools for cleaning, fracturing, and perforating; rotating drill string; advancing (extending) the wellbore; withdrawing a drill string; and/or withdrawing coiled tubing. For purposes of the present disclosure, drilling operations include the interaction of the drill string with the cased-hole or the open-hole as the drill string or tubing is moved, withdrawn, advanced and/or rotated. Furthermore, drilling operations also comprise the movement of coiled tubing inside the cased-hole or the open-hole; introducing casing; introducing screens; introducing tools for cleaning, fracturing, and perforating; rotating the drill string; advancing (extending) the wellbore; withdrawing a drill string; and/or withdrawing coiled tubing.

As used herein, the term “liquid friction reduction additive” refers to a substance that exists in a liquid form or a dissolved form under the temperature and pressure conditions present in a given application, such as within a wellbore.

For the purposes of the present disclosure, the new numbering scheme for the Periodic Table Groups is used. In said numbering scheme, the groups (columns) are numbered sequentially from left to right from 1 through 18, excluding the f-block elements (lanthanides and actinides).

The terms “group,” “radical” and “substituent” are used interchangeably herein.

The term “hydrocarbon” refers to a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different numbers of carbon atoms. The term “Cₙ” refers to a hydrocarbon compound or a hydrocarbyl group having n carbon atom(s) per molecule or group, wherein n is a positive integer. Such hydrocarbons or hydrocarbyl groups may be one or more of linear, branched, cyclic, acyclic, saturated, unsaturated, aliphatic, or aromatic.

The terms “saturated” or “saturated hydrocarbon” refer to a hydrocarbon or hydrocarbyl group in which all carbon atoms are bonded to four other atoms or are bonded to three other atoms with one unfilled valence position thereon.

The terms “unsaturated” or “unsaturated hydrocarbon” refer to a hydrocarbon or hydrocarbyl group in which one or more carbon atoms are bonded to less than four other atoms, optionally with one unfilled valence position on the one or more carbon atoms.

The terms “linear” and “linear hydrocarbon” refer to a hydrocarbon or hydrocarbyl group having a continuous carbon chain without side chain branching, in which the continuous carbon chain may be optionally substituted with heteroatoms or heteroatom groups.

The terms “branch,” “branched” and “branched hydrocarbon” refer to a hydrocarbon or hydrocarbyl group having a linear main carbon chain in which a hydrocarbyl side chain extends from the linear main carbon chain. Optional heteroatom substitution may be present in the linear main carbon chain or in the hydrocarbyl side chain.

The terms “hydrocarbyl” and “hydrocarbyl group” are used interchangeably herein. The term “hydrocarbyl group” refers to any C₁-C₁₀₀ hydrocarbon group bearing at least one unfilled valence position when removed from a parent compound. For example, the skilled person will understand that in view of the structure of Component 1, Component 2, and Component 2′ described herein, moieties A (Component 1) and D (Component 2′) will have one unfilled valence position when removed from the parent compound, whereas moiety B (Component 2) will have two unfilled valence positions when removed from the parent compound. “Hydrocarbyl groups” may be optionally substituted, in which the term “optionally substituted” refers to replacement of at least one hydrogen atom or at least one carbon atom with a heteroatom or heteroatom functional group. Heteroatoms may include, but are not limited to, B, O, N, S, P, F, Cl, Br, I, Si, Pb, Ge, Sn, As, Sb, Se, and Te. Heteroatom functional groups that may be present in substituted hydrocarbyl groups include, but are not limited to, functional groups such as O, S, S═O, S(═O)₂, NO₂, F, Cl, Br, I, NR₂, OR, SeR, TeR, PR₂, AsR₂, SbR₂, SR, BR₂, SiR₃, GeR₃, SnR₃, PbR₃, where R is a hydrocarbyl group or H. Suitable hydrocarbyl groups may include alkyl, alkenyl, alkynyl, aryl, heteroaryl, cycloalkyl, cycloalkenyl, heterocyclyl, and the like, any of which may be optionally substituted.

The term “alkyl” refers to a hydrocarbyl group having no unsaturated carbon-carbon bonds, and which may be optionally substituted. The term “alkylene” refers to an alkyl group having at least two open valence positions upon different carbon atoms.

The term “alkenyl” refers to a hydrocarbyl group having a carbon-carbon double bond, and which may be optionally substituted. The terms “alkene” and “olefin” may be used synonymously herein. Similarly, the terms “alkenic” and “olefinic” may be used synonymously herein. Unless otherwise noted, all possible geometric and positional isomers are encompassed by these terms.

The terms “alkoxy” or “alkoxide” refer to an alkyl ether or aryl ether group having an open valence position upon the oxygen atom, wherein the term alkyl is as defined above. Examples of suitable alkyl ether groups include, but are not limited to, methoxy, ethoxy, n-propoxy, iso-propoxy, n-butoxy, iso-butoxy, sec-butoxy, tert-butoxy, phenoxy, and the like.

The terms “aromatic” and “aromatic hydrocarbon” refer to a hydrocarbon or hydrocarbyl group having a cyclic arrangement of conjugated pi-electrons that satisfy the Hückel rule. The term “aryl” is equivalent to the term “aromatic” as defined herein. The term “aryl” refers to both aromatic compounds and heteroaromatic compounds, either of which may be optionally substituted. Both mononuclear and polynuclear aromatic compounds are encompassed by these terms. Heteroatoms within a heteroaromatic compound may include one or more of O, N, S or any combination thereof.

Examples of saturated hydrocarbyl groups include, but are not limited to, methyl, ethyl, n-propyl, isopropyl, n-butyl, isobutyl, sec-butyl, tert-butyl, pentyl, isopentyl, hexyl, octyl, cyclopropyl, cyclobutyl, cyclopentyl, cyclohexyl, cyclooctyl, and the like, including their substituted analogues. Examples of unsaturated hydrocarbyl groups include, but are not limited to, ethenyl, propenyl, allyl, butadienyl, cyclopropenyl, cyclobutenyl, cyclopentenyl, cyclohexenyl, cyclooctenyl and the like, including their substituted analogues.

Examples of aromatic hydrocarbyl groups include, but are not limited to, phenyl, tolyl, xylyl, naphthyl, and the like, including all possible isomeric forms thereof. Polynuclear aromatic hydrocarbyl groups may include, but are not limited to, naphthalene, anthracene, indane, and indene.

The term “oligomer” refers to a molecule having multiple repeating or non-repeating structural units (monomer units), where the number of repeating monomer units is relatively small and below a predetermined molecular weight threshold. Illustrative oligomers include dimers, trimers, tetramers, other higher oligomers, and mixtures thereof. For purposes of the present disclosure, the term “higher oligomer” refers to an oligomer larger than a dimer.

The term “mineral acid” refers to inorganic Brønsted acids in an aqueous solution. The term “aqueous” as used herein refers to a composition wherein the solvent comprises at least 50 wt. % water, preferably at least 80 wt. %, or even at least 90 wt. %. Non-limiting examples of mineral acids include hydrochloric acid, hydrobromic acid, nitric acid, sulfuric acid, boric acid, phosphoric acid, and perchloric acid.

The person of ordinary skill in the art will recognize that hydroxyl groups on the oligomers described herein are subject to deprotonation and may form salts with a suitable counterion. Some suitable counterions include, but are not limited to, Group 1-2 metals, and organic cations (e.g., NR₄⁺ and PR₄⁺ groups), where each R group is independently selected from H and hydrocarbyl groups. In any embodiment described herein, Group 1-2 metals includes Li, Na, K, Rb, Cs, Fr, Be, Mg, Ca, Sr, Ba, and Ra. Particularly suitable Group 1-2 metals may include Li, Na, K, Cs, Mg and Ca.

As used herein, the term “heterogeneous blend” refers to a composition having two or more morphological phases in the same state. For example a blend of immiscible components (e.g., oil and water), where one component forms discrete packets dispersed in a matrix of another component is said to be heterogeneous. The term “continuous phase” refers to the matrix of a heterogeneous blend. The term “discontinuous phase” refers to the dispersed phase in a heterogeneous blend. Continuous phases herein may be oil-based or water-based.

Bulk conditions of a drilling operation may include, for example, temperatures in the wellbore ranging from a low of about 50° C., 60° C., 70° C., 80° C., 90° C., 100° C., or 125° C. to a high of about 170° C., and pressures ranging from ambient pressure to a high of about 100 bar (10,000 kPa), 200 bar (20,000 kPa), 300 bar (30,000 kPa), 400 bar (40,000 kPa), 500 bar (50,000 kPa), or 600 bar (60,000 kPa). Such bulk conditions may also be referred to herein using the terms “bulk wellbore conditions” or “bulk conditions in a wellbore,” for example.

Kinematic viscosity (also referred to as “viscosity”) is determined by ASTM D445, and is typically measured at 40° C. (Kv40) or 100° C. (Kv100). If temperature is not indicated when specifying a kinematic viscosity, the viscosity is Kv100.

Reaction Products of Monofunctional and Bifunctional Epoxides

Compositions of the present disclosure may have lubricant properties and comprise an optional carrier fluid, particularly a carrier fluid comprising about 1.0 wt. % to about 95 wt. % water, and one or more reaction products combined with the carrier fluid. The one or more reaction products are formable from compounds comprising a nucleophile-bearing hydrocarbyl group and a monofunctional and/or bifunctional epoxide compound, wherein epoxide ring opening of the monofunctional and/or bifunctional epoxide compound may occur at various reaction stages and in several different manners, as discussed herein. More specifically, the one or more reaction products may be formable from Component 1 and Component 2; Component 1 and Component 2′; Component 2′; Component 1, Component 2, and Component 2′; or any combination thereof

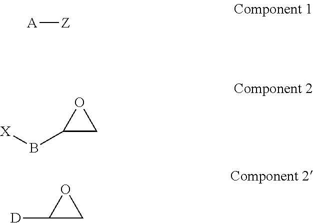

and an acid and water combined therewith. In case the reaction products are formable or formed from Component 1 and Component 2, the acid and water is preferably added after at least Component A has formed as an initial reaction product;

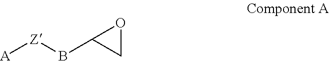

wherein A, B, D, X, Z, and Z′ are as defined above.

Optionally, Component A or any other initial reaction product maybe isolated and/or purified before undergoing a reaction with the acid and/or forming higher oligomers.

The acid may be selected from a mineral acid, a sulfonic acid, a sulfinic acid, a phosphonic acid, a phosphinic acid, or any combination thereof. In preferred embodiments,
the sulfonic acid is of the formula R¹—S(═O)₂—OH;
the sulfinic acid is of the formula R²—S(═O)—OH;
the phosphonic acid is of the formula R³—P(═O)(OH)₂; and
the phosphinic acid is of the formula R⁴—P(R⁵)(═O)—OH;
   wherein R¹, R², R³, R⁴, and R⁵ independently are a branched or unbranched, cyclic or acyclic, substituted or unsubstituted, saturated or unsaturated C₁-C₁₀₀ hydrocarbyl group. Preferably, IV, R², R³, R⁴, and R⁵ are independently C₁-C₂₀ alkyl, more preferably C₁-C₁₀ alkyl, and most preferably C₁-C⁵ alkyl.

A, B and D may be the same or different and are independently chosen from branched or unbranched, cyclic or acyclic, substituted or unsubstituted, saturated or unsaturated C₁-C₁₀₀ hydrocarbyl groups, which may include alkyl, cycloalkyl, alkenyl, cycloalkenyl, alkynyl, cycloalkynyl, aromatic, heteroaromatic, or heterocyclic groups, or any combination thereof. In preferred embodiments, A and D are selected from branched or unbranched, cyclic or acyclic, substituted or unsubstituted, saturated or unsaturated C₁-C₄₀ hydrocarbyl groups, which may include alkyl, cycloalkyl, alkenyl, cycloalkenyl, alkynyl, cycloalkynyl, aromatic, heteroaromatic, or heterocyclic groups, or any combination thereof. In preferred embodiments, B is C₁-C₅ alkyl. In particular embodiments, Component 2 is epichlorohydrin or epibromohydrin.

Z is a nucleophilic group selected from OH, SH, NH₂, preferably OH; and X is a leaving group displacable by the nucleophilic group. Suitable leaving group may include, for example, halides (e.g., chloride, bromide, or iodide) or halide equivalents, such as sulfonates (e.g., methanesulfonate, toluenesulfonate, trifluoromethanesulfonate, or the like). It is to be appreciated that the foregoing nucleophilic groups may undergo deprotonation in the presence of a base to form the corresponding counterion, in which case the counterion may function as the actual nucleophilic species when forming the reaction products described herein.

The one or more reaction products may comprise a plurality of reaction products, including a range of oligomeric reaction products in some instances. In other instances, the one or more reaction products may constitute a single or predominant reaction product.

The reaction product disclosed herein may comprise an oligomer formable by reacting Component 1 and Component 2, an oligomer formable by reacting Component 1 and Component 2′, an oligomer formable by self-oligomerizing Component 2′, or an oligomer formable by reacting Component 1, Component 2 and Component 2′. In any embodiment, self-oligomerized oligomers of Component 2′ may be absent from the reaction products described herein.

In embodiments where the one or more reaction products are formable from reacting Component 1 and Component 2, the initial reaction products may comprise at least Component A, which is formable in accordance with Reaction 1 below.

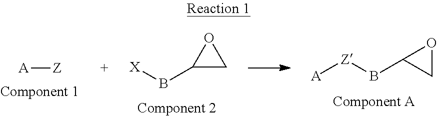

As shown, a nucleophilic coupling reaction takes place to form Component A by displacement of leaving group X with nucleophilic group Z. In Component A, hydrocarbyl groups A and B remain defined as above, and Z′ is a spacer group (formed from nucleophilic group Z) that is selected from O (if Z is OH), S (if Z is SH), and NH (if Z is NH₂). Component A may undergo additional reactions to form higher oligomers, as discussed further below.

In embodiments wherein the one or more reaction products are formable from reacting Component 1 and Component 2′, Components Z′ and/or Z″ may be present in the initial reaction products as well, wherein the variables are further defined as above.

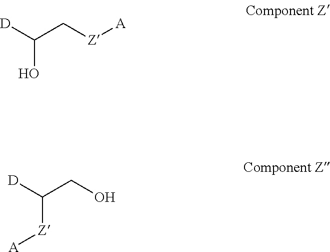

One or both of Components Z′ and Z″ may be formable by a nucleophilic epoxide ring-opening reaction between Component 1 and Component 2′, as shown in Reaction 1′ below.

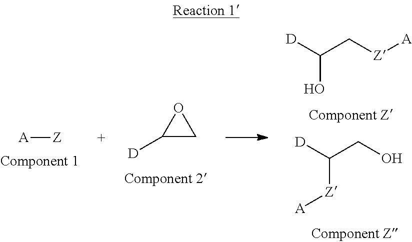

Components Z′ and Z″ may undergo additional reactions to form higher oligomers, as discussed further below. Component 2′ also may undergo nucleophilic ring-opening through a reaction with hydroxyl groups, including those generated in higher oligomers, as discussed further below, wherein Component 1 does not participate in the nucleophilic ring-opening reaction.

Suitable hydrocarbyl groups may include methyl or ethyl, as well as branched and unbranched, cyclic and acyclic, isomers of propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, docosyl, tricosyl, tetracosyl, and unsaturated variants of any of the foregoing except methyl, particularly wherein the unsaturation is in the form of one or more double bonds. For the A and D moieties, suitable hydrocarbyl groups may contain a carbon backbone having at least ten carbon atoms, or at least fifteen carbon atoms, which may be optionally branched and/or substituted. Suitable substitutions may include, for example, —OH, —OR, —NH₂, —NHR, —NR₂, —NO₂—CHO, —SO₂R, —CO₂H, —CO₂R, —CO₂NH₂, —CO₂NHR, —CO₂NR₂, —SO₂NH₂, —NHSO₂R, —SO₂NHR, —SO₂NR₂, —NRSO₂R, —SOR, polyamines, polyols, oxazolidines, Group 1-2 metals, NR₄⁺ groups, PR₄⁺ groups, and a glycosyl group, wherein R is a hydrocarbyl group. Alternatively or additionally, at least one carbon atom of the hydrocarbyl group may be substituted (replaced) with at least one heteroatom or heteroatom-containing functional group. Suitable heteroatoms may include, for example, S (sulfur), O (oxygen), N (nitrogen), and P (phosphorus). Particularly suitable heteroatom-containing functional groups may include carbonyl and amide.

Once formed, Component A may undergo epoxide opening in the presence of the acid to form the corresponding diol or diol monoester, depending upon the acid added to the reaction mixture after formation of Component A. The acid is preferably added after most or all of Component 2 is consumed in the initial reaction. In particular embodiments, the acid is added after at least 90% of the initial amount of Component 2 has reacted, preferably at least 95%, most preferably at least 99%. In other words, Component 1 and Component 2 are preferably reacted until less than 10% of the initial amount of Component 2 remains, preferably less than 5%, most preferably less than 1%; then the acid is added. The skilled person will understand that even if less than 1% of Component 2 remains, the reaction mixture can still contain other epoxides such as Component A.

The corresponding diol or diol monoester of Component 2′ may form similarly. However, in contrast with Component 2, Component 2′ may be combined directly with the acid (and water), i.e. without prior reaction between Component 1 or other components. Mineral acids, such as aqueous hydrochloric acid, hydrobromic acid, nitric acid, or sulfuric acid, for example, may form the corresponding diol of Component A having a structure represented by Component A′, and Component 2′ may form the corresponding diol having a structure represented by Component A″.

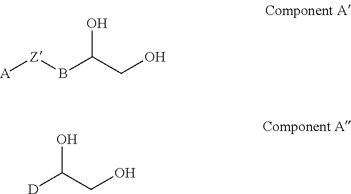

Sulfonic acids, sulfinic acids, phosphonic acids, or phosphinic acids, in contrast, may produce Component B and/or Component C as defined above, i.e. the corresponding sulfonate, sulfinate, phosphonate, or phosphinate monoester upon opening the epoxide, wherein either carbon atom of the ring-opened epoxide may bear the sulfonate, sulfonate, phosphonate, or phosphinate group. In the case of epoxide opening of Component A being conducted with an alkylsulfonic acid (e.g., methanesulfonic acid), diol monoesters corresponding to Component B′, Component C′, or any combination thereof may be formed.

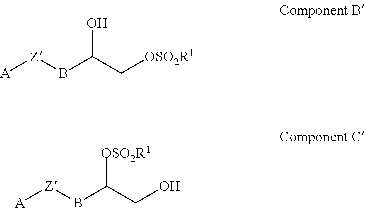

In Components B′ and C′, R¹ is a branched or unbranched, cyclic or acyclic, substituted or unsubstituted, saturated or unsaturated C₁-C₁₀₀ hydrocarbyl group, which may be alkyl, cycloalkyl, alkenyl, cycloalkenyl, alkynyl, cycloalkynyl, aromatic, heteroaromatic, or heterocyclic, or any combination thereof, and the other variables are defined as above. In preferred embodiments, R¹ is C₁-C₁₀ alkyl. When methanesulfonic acid is used to promote opening of the epoxide, R¹ is a methyl group.

Any combination of reaction products may be formed in the disclosure herein, with the following proviso. If the one or more reaction products comprises Component A′, Component A″, or any combination thereof, the one or more reaction products further comprises at least one additional oligomer differing from Component A′ and Component A″ and selected from at least one oligomer formable from Component A, at least one oligomer formable from Component A′, at least one oligomer formable from Component A″, at least one oligomer formable from Component 2, at least one oligomer formable from Component 2′, and any combination thereof. That is, compositions of the present disclosure may not comprise Component A′ and/or Component A″ alone. Suitable oligomers of Component 2′, including oligomers of Components Z′ and Z″ that may be present and their formation are discussed hereinafter. Component A′ may be formed by opening the epoxide of Component A with a mineral acid, as discussed herein. It is to be appreciated that minor amounts of Component A′ may also be formed when opening the epoxide of Component A with a sulfonic acid, sulfinic acid, a phosphonic acid, or a phosphinic acid, typically due to the presence of trace or non-trace amounts of water in the reaction mixture. Minor amounts of Component A″ may be formed similarly when opening the epoxide of Component 2′ with a sulfonic acid, sulfinic acid, a phosphonic acid, or a phosphinic acid.

As discussed above, Components B and C may be formed from Component A when the acid is a sulfonic acid, a sulfinic acid, a phosphonic acid, or a phosphinic acid; with minor formation of Component A′ also being possible. An oligomer formable from Component A, an oligomer formable from Component A′, an oligomer formable from Component A″, an oligomer formable from Component 2, and/or an oligomer formable from Component 2′ is not required to be present in the one or more reaction products in combination with Component B or Component C in the present disclosure, although oligomers may be present in many instances. Similarly, higher oligomers of Component B or Component C are not required to be present in combination with Component B or Component C. That is, reaction products suitable for use in the disclosure herein may comprise Component B or Component C without other oligomers being present.

Component A′ may be formable from Component A when the acid comprises a mineral acid, as shown in Reaction 2 below. Component A″ may be correspondingly formable from Component 2′, as shown in Reaction 2′ below. Minor amounts of

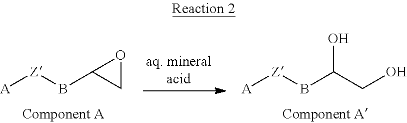

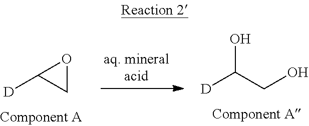

Component A′ and/or Component A″ may also be formed in the presence of other acids when trace or non-trace amounts of water are present in the reaction mixture. Depending on the reaction conditions and how soon the reaction mixture is sampled after the mineral acid is combined with the reaction mixture, Component A′ may or may not be present in the one or more reaction products (e.g., if even higher oligomers have formed). For example, if Component A′ has not yet had time to fully react to form one or more higher oligomers, as discussed hereinafter, at least some Component A′ may persist in the reaction mixture. Again, provided that specified oligomers differing from Component A′ and Component A″ are present, Component A′ and/or Component A″ may be present in the reaction products. When using a mineral acid, the one or more reaction products will typically comprise some Component A′ and/or Component A″ in combination with the one or more oligomers.

Accordingly, when a mineral acid is combined with the reaction mixture, or after isolating one or more initial reaction products and combining the one or more initial reaction products with the mineral acid, the one or more reaction products may comprise an oligomer formable from Component A, an oligomer formable from Component A′, or any combination thereof, optionally in further combination with Component A′. An oligomer or reaction product formable from Component 2′ may similarly be present in combination with Component A″, an oligomer formable from Component A, and an oligomer formable from Component A′.

In one instance, oligomers of Component A may be formable from a nucleophilic epoxide ring-opening reaction between Component A and Component 1, as shown in Reaction 3 below.

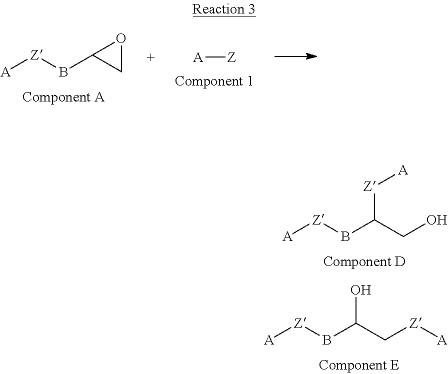

As shown, either of two possible regioisomers (Component D or Component E) or a combination thereof may form in any product distribution. Still further higher oligomers of Component D or Component E may form, for example by a nucleophilic coupling reaction with Component A and either one of Component D and Component E.

Further higher oligomers of Component D or Component E may also form as shown below in Reactions 3′ and 3″, wherein

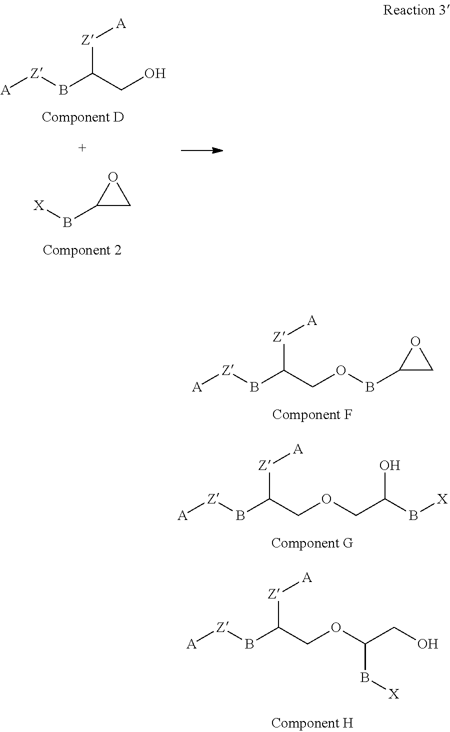

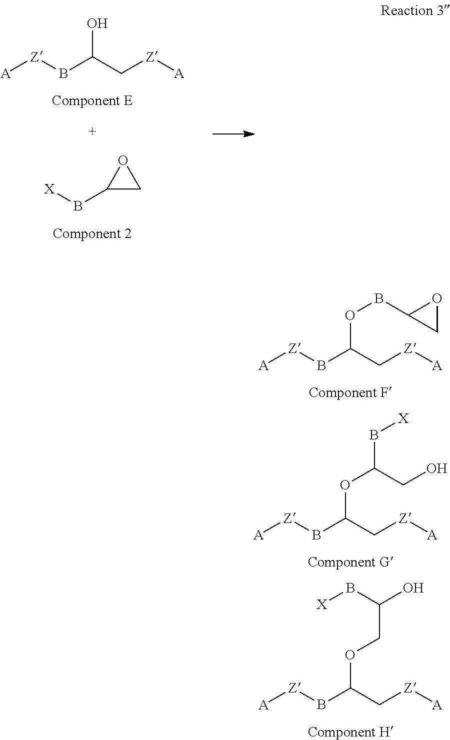

Components F and F′ may be formable by a nucleophilic coupling reaction with Component 2, and Components G, G′, H and H′ may be formable by a nucleophilic epoxide ring-opening reaction with Component 2. The skilled person will understand that in embodiments where the acid is added after Component 2 is consumed, Reactions 3′ and 3″ will not occur to any significant extent. Nevertheless, similar reactions may occur between Component A and either of Component D or Component E.

Higher oligomers of Component A′ may be formable by a nucleophilic epoxide ring-opening reaction between Component A′ and Component 2, a nucleophilic coupling reaction between Component A′ and Component 2, or any combination thereof, as shown in Reactions 4 and 5 below. Either of the two hydroxyl groups of the diol may undergo the

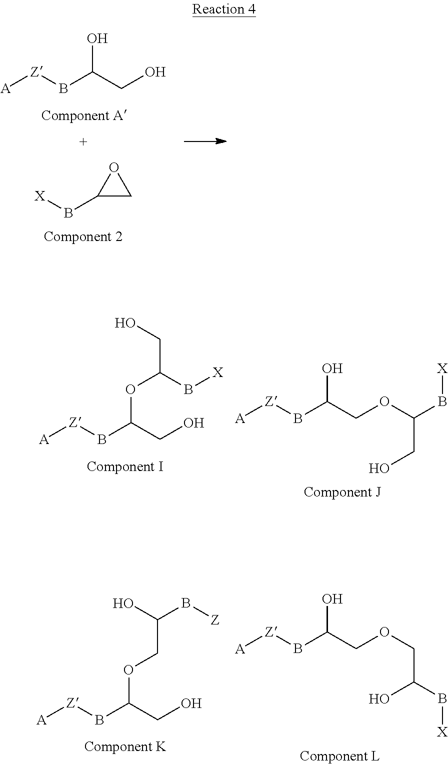

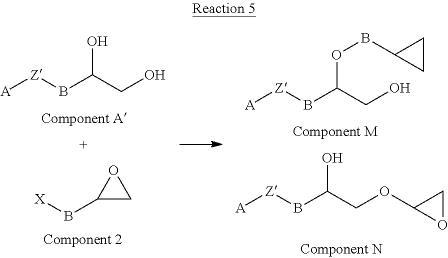

reactions shown in Reactions 4 and 5. Although Reactions 4 and 5 have shown the reaction of only one of the hydroxyl groups, it is to be appreciated that both of the hydroxyl groups may undergo a reaction in some instances. Moreover, it is to be appreciated that the remaining hydroxyl groups in Components I-N may undergo further reactions to form still higher oligomers, such as through serving as a nucleophile to promote nucleophilic coupling in the presence of a suitable leaving group and/or to promote epoxide opening. Similar reactions have been discussed above. The skilled person will understand that in embodiments where the acid is added after Component 2 is consumed, Reactions 4 and Swill not occur to any significant extent. Nevertheless, similar reactions as in Reaction 4 may occur between Component A′ and Component A instead of Component 2.

As shown in Reaction 4, either of free hydroxyl groups in Component A′ may react nucleophilically with the epoxide group of Component 2 to form any of 4 possible isomeric products (Components I-L) in any product distribution; and similar reactions may occur between Component A′ and Component A. As shown in Reaction 5, either of the free hydroxyl groups in Component A′ may also react nucleophilically with leaving group X in Component 2 (if present) to form any of the two possible regioisomeric nucleophilic coupling reaction products (Components M and N) in any product distribution. Components I-L and M and N may be formed concurrently with one another or exclusively of one another depending on particular reaction rates for epoxide ring opening versus nucleophilic displacement. Still further higher oligomers may form, such as through the hydroxyl groups in Components I-L promoting a nucleophilic reaction and/or the epoxide ring in Components M and N undergoing nucleophilic opening or hydrolysis.

In the presence of a suitable organic acid, such as a sulfonic acid, a sulfinic acid, a phosphonic acid or a phosphinic acid, Component A may form Component B and/or Component C; i.e. a monosulfonate, a monosulfinate, a monophosphonate, or a monophosphinate ester upon epoxide ring opening. Reaction 6 below shows the regioisomeric monosulfonate reaction products that may form when a sulfonic acid is used to promote epoxide ring opening in the present disclosure, wherein Component B′ and/or Component C′ may be formed in any product distribution ratio with respect to one another.

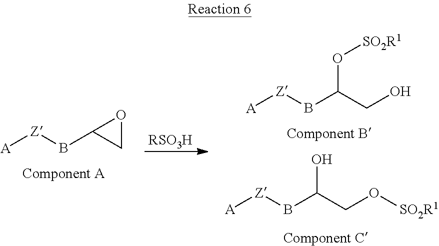

R¹ is defined as above, and may be an alkyl group, particularly a methyl group, in certain instances. Component A, Component A′ (if minor amounts are present after opening the epoxide with an organic acid), Component B, Component C or any combination thereof may react further to form higher oligomers according to the disclosure herein, as discussed further hereinafter.

It is to be appreciated that when the epoxide of Component A undergoes ring opening in the presence of a sulfonic acid, small amounts of Component A′ may also form due to the presence of trace or non-trace amounts of water in the reaction mixture. Higher oligomers of Component A′ may be subsequently formed therefrom (Reactions 4 and 5).

Accordingly, when a sulfonic acid is introduced to the reaction mixture after at least Component A has formed as an initial reaction product, the one or more reaction products may comprise any of an oligomer formable from Component A, Component A′, an oligomer formable from Component A′, Component B, an oligomer formable from Component B, Component C, an oligomer formable from Component C, an oligomer or reaction product formable from Component 2, an oligomer or reaction product formable from Component 2′, or any combination thereof.

Oligomers of Component A may be formable as shown in Reaction 3 above to afford Component D or Component E in any product distribution. The free hydroxyl group in Component D or Component E may subsequently promote formation of still higher oligomers of Component D or Component E in a manner identical to that shown in Reactions 3′ and/or 3″, wherein the free hydroxyl group may promote nucleophilic coupling (Reaction 3′) or nucleophilic opening of the epoxide (Reaction 3″).

When present, oligomers of Component A′ may be formed as shown in Reactions 4 and/or 5 above to produce one or more of Components I-N or M and N in any product distribution. The free hydroxyl group in any of Components I-N may subsequently promote formation of still higher oligomers by undergoing a nucleophilic coupling reaction with leaving group X or nucleophilically opening the epoxide ring of Component 2 or Component 2′.

Higher oligomers of Component B may be formable from a nucleophilic epoxide ring-opening reaction between Component B and Component 2 to form regioisomeric Components O and Component P or through a nucleophilic coupling reaction between Component B and Component 2 to form Component Q, as shown in Reaction 7 below. Components O-Q may be formed in any product distribution. The free hydroxyl group serves as the nucleophile in both instances. A similar reaction may occur between Component B and Component A.

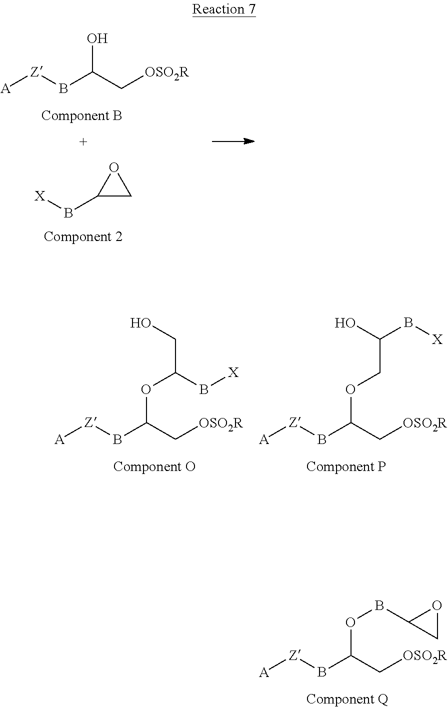

Oligomers of Component C may be formed correspondingly, as shown in Reaction 7′ below, wherein Components O′-Q′ may be formed. Again, a similar reaction may occur between Component C and Component A.

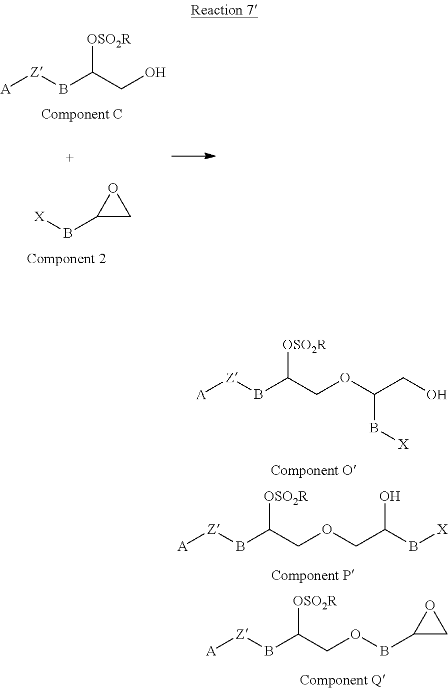

When present, either alone or in combination with Component 1, Component 2′ may undergo a similar set of reactions to form reaction products and/or oligomers thereof through any combination of nucleophilic coupling and/or nucleophilic epoxide ring-opening reactions depending upon other components that are present. The formation of Component A″, which is formable through hydrolytic epoxide ring opening of Component 2′, is shown in Reaction 1′ above. Other non-limiting examples of reaction products and oligomers of Component 2′ may be formed in accordance with Reactions 8-18 below. In the interest of brevity, the transformations taking place in Reactions 8-18 are not described in detail and may be better understood by referencing the other reactions shown above. When both Components 2 and 2′ and/or an oligomerized variant thereof are present, epoxide ring-opening reactions of either epoxide ring may take place to form mixed higher oligomers in some cases. The nucleophile for promoting the epoxide ring-opening reaction may comprise the nucleophilic group of Component 1 and/or a hydroxyl group resulting from epoxide ring-opening of another molecule. The skilled person will understand that whereas Reaction 9, Reaction 11, and Reaction 12 are shown for reaction products obtained with sulfonic acid, analogous reactions may occur when using a sulfinic acid, a phosphonic acid for the epoxide ring opening. In such reactions, Components B′, C′, X′, and Y′ are replaced with the corresponding Components B, C, X, and Y as defined above; and the reaction products are changed accordingly.

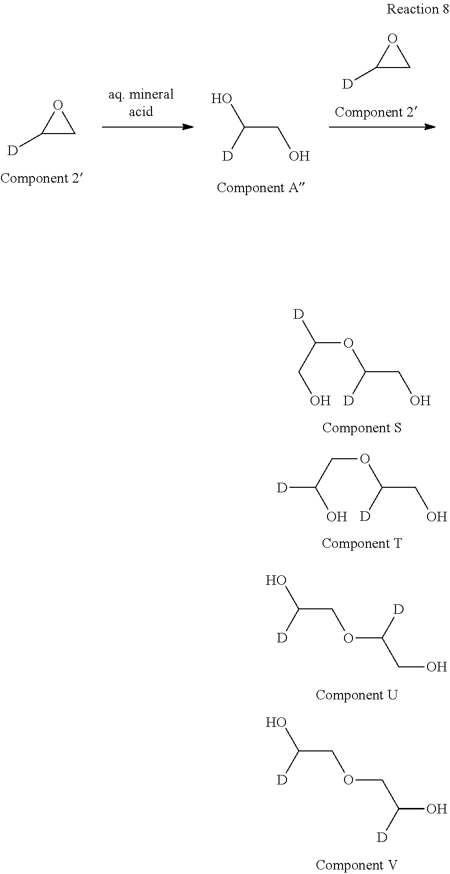

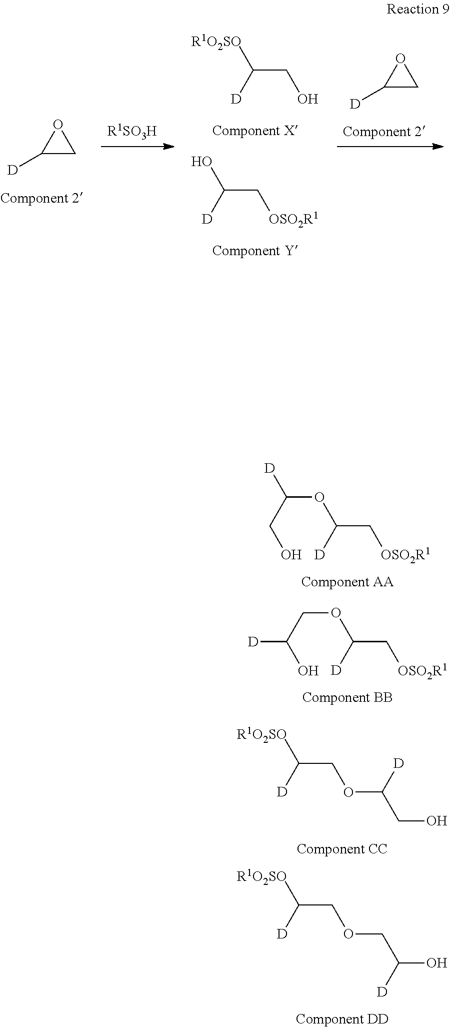

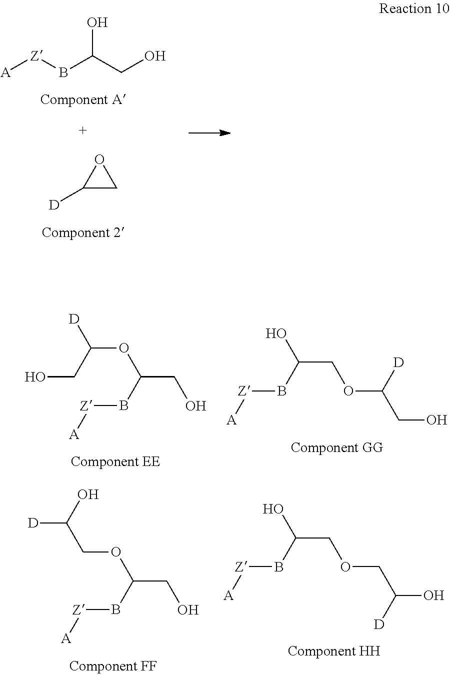

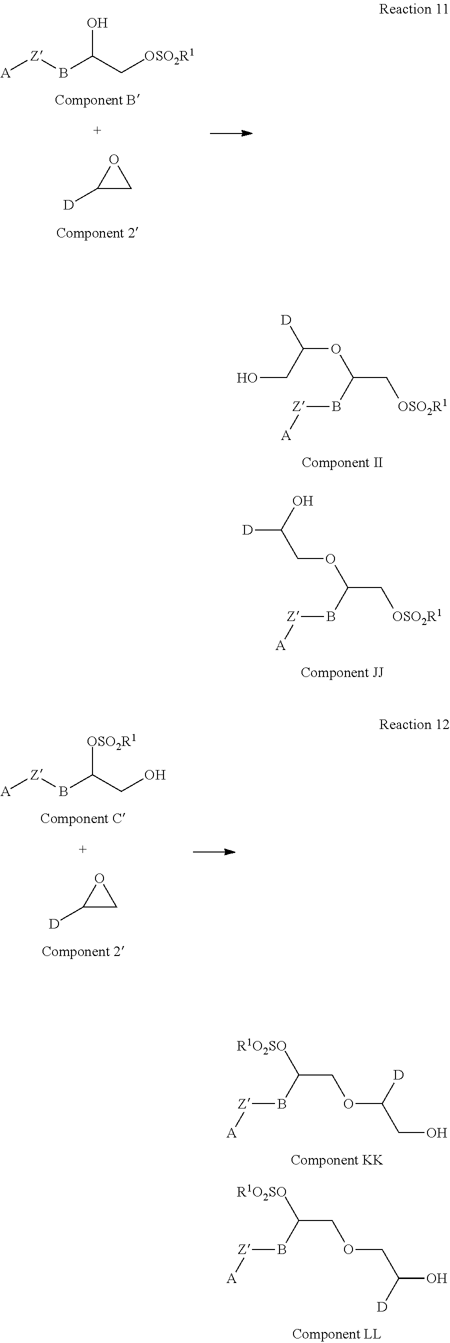

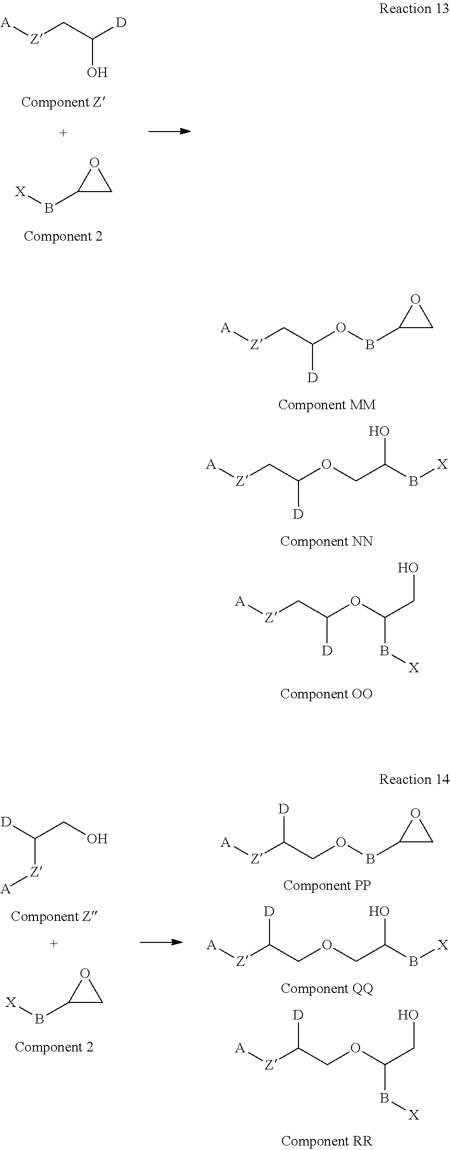

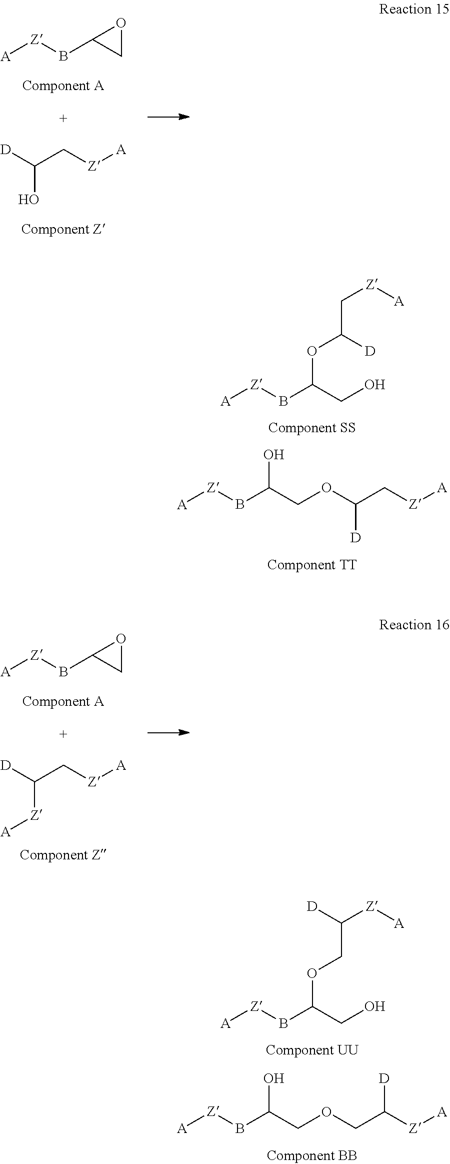

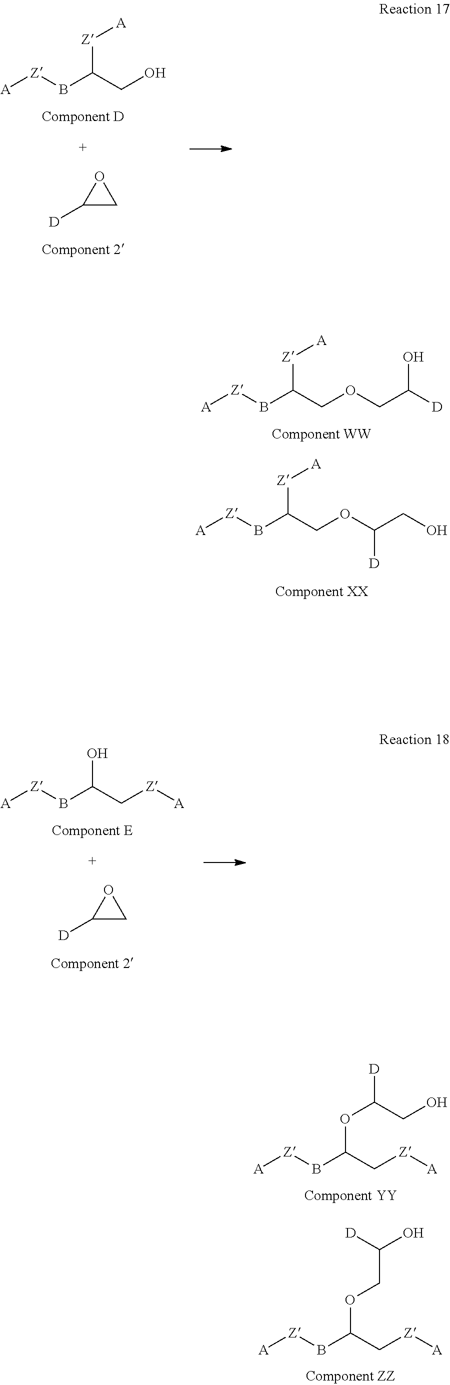

Again, it is to be appreciated that the transformations shown in Reactions 8-18 are illustrative of those that may take place according to the disclosure herein. In non-limiting examples, nucleophilic group Z, when present, may promote a nucleophilic coupling reaction or a nucleophilic epoxide ring-opening reaction of any epoxide ring that is present. Similarly, any hydroxyl group, regardless of how or where generated, may promote a nucleophilic coupling reaction of a nucleophilic epoxide ring-opening reaction with any other component bearing a leaving group or an epoxide ring. In view of the above, the skilled person will understand that the oligomers referred to herein are obtained via nucleophilic coupling reactions or nucleophilic epoxide ring-opening reactions as described herein, and not via other polymerization mechanisms, such as the polymerization of olefins (e.g. via double bonds which may be present in hydrocarbyl groups A, B, D, R¹, R², R³, R⁴, or R⁵.

It is also to be appreciated that still higher oligomers may be formed from any of the reaction products described herein. By way of non-limiting example, any reaction product bearing an epoxide may undergo nucleophilic epoxide ring-opening with nucleophilic group Z of Component 1 or a free hydroxyl group in any of the reaction products described herein. Similarly, any reaction product bearing a free hydroxyl group may undergo a nucleophilic epoxide ring-opening reaction with Component A (or Component 2′). Alternately, any reaction product bearing a free hydroxyl group may undergo a nucleophilic coupling reaction with any reaction product bearing leaving group X or promote epoxide ring-opening with any reaction product bearing an epoxide group. The sulfonate groups in Components B, C, O-Q, O′-Q′, X, Y, AA-DD, or II-LL, by way of non-limiting examples, may undergo nucleophilic displacement with nucleophilic group Z of Component 1 or another suitable hydroxyl group nucleophile, as well to form still other alternative higher oligomers. Any free hydroxyl groups or epoxide groups generated or appended to the higher oligomers during these reactions may undergo subsequent oligomerization as well. As such, it can be readily appreciated that the reaction products described herein may exhibit a significant breadth of structural and molecular weight diversity. Accordingly, the illustrative molecular structures provided herein are not considered to limit the breadth of the reaction products that may be obtained. Provided that the one or more reaction products are a liquid or are dissolvable to form a liquid solution, any reaction product consistent with the foregoing description may be employed in the disclosure herein.

In any embodiment of the present disclosure, nucleophilic group Z may be OH, SH, or NH₂, thereby leading to Z′ being 0, S, or NH, and A may be a branched or unbranched, cyclic or acyclic, substituted or unsubstituted, saturated or unsaturated C₁₀-C₃₀ hydrocarbyl group. The acid may be a mineral acid or a sulfonic acid in any of these embodiments.

The composition described herein may essentially consist of the one or more reaction products, or may contain further components, depending on the intended use of the composition. For example, the one or more reaction products may be provided with a carrier fluid as described further herein. In certain embodiments, the one or more reaction products may be provided in a highly concentrated form, and are diluted with the one or more carrier fluids by the end user. In particular embodiments, the composition described herein contains from 0.1 wt. % to 100 wt. % of the one or more reaction products. In further embodiments, the composition may contain at least 5 wt. %, at least 10 wt. %, at least 20 wt. %, at least 50 wt. % of the one or more reaction products.

In particular embodiments, the compositions described herein may be used in combination with a carrier fluid in drilling muds, where the reaction products in the composition can act as a friction reducing additive. Such drilling muds and carrier fluids are described further below. Furthermore, the compositions described herein may also be used as an additive in rolling oils, hydraulic fluids, and engine oils, where it may enhance friction-reducing properties. Other potential applications of the compositions described herein and the reaction products as such include, but are not limited to:
spray oils for use in agriculture, where the reaction products can be used in combination with an active ingredient (such as a pesticide, insecticide, herbicide, and the like) and a carrier fluid such as water;
enhanced oil recovery, where the reaction products can be used as a surfactant;
additive to polymer formulations, where the reaction products can be used for surface modification;
plasticizer in plastics such as polyvinyl chloride (PVC);
corrosion inhibitor and/or construction steel coating, by virtue of the reaction product's ability to adhere to metal surfaces; and
dispersants.

The skilled person will understand that for many applications, it will be preferred that the composition is free or almost free of the one or more acids that used for the epoxide ring opening reaction. In particular embodiments, the molar ratio of the one or more reaction products to the one or more acids is at least 50, preferably at least 100. In some embodiments, the compositions described herein have a pH of at least 3.

Carrier Fluids

Suitable carrier fluids are not considered to be particularly limited and may be an aqueous carrier fluid in any embodiment of the present disclosure. In particular examples, the carrier fluid may comprise an oil-based drilling mud, a water-based drilling mud, or an aqueous completion fluid. Suitable examples of various types of carrier fluids are provided hereinafter.

In any embodiment, the compositions of the present disclosure may comprise about 90 wt. % to about 99 wt. % of the carrier fluid and about 1 wt. % to about 10 wt. % of the one or more reaction products. In any embodiments, the carrier fluid may comprise about 1.0 wt. % to about 95 wt. % water or about 1.0 wt. % to about 99 wt. % water. Any combination of the reaction products disclosed herein may be present in the carrier fluid.

Other suitable amounts for the carrier fluid may include about 50 wt. % or greater, about 55 wt. % or greater, about 60 wt. % or greater, about 65 wt. % or greater, about 70 wt. % or greater, about 75 wt. % or greater, about 80 wt. % or greater, about 85 wt. % or greater, about 90 wt. % or greater, about 95 wt. % or greater, or about 97 wt. % or greater. Additionally or alternatively, suitable amounts of the carrier fluid may be about 99 wt. % or less, about 97 wt. % or less, about 95 wt. % or less, about 90 wt. % or less, about 85 wt. % or less, about 80 wt. % or less, about 75 wt. % or less, about 70 wt. % or less, about 65 wt. % or less, about 60 wt. % or less, about 55 wt. % or less, or about 50 wt. % or less. Suitable ranges for the carrier fluid may include about 50 wt. % to about 99 wt. %, about 55 wt. % to about 97 wt. %, about 60 wt. % to about 95 wt. %, or about 65 wt. % to about 90 wt. %.

Other suitable amounts at which the one or more reaction products may be disposed in the carrier fluid include, for example, about 0.5 wt. % or greater, about 1 wt. % or greater, about 1.5 wt. % or greater, about 2 wt. % or greater, about 2.5 wt. % or greater, about 3 wt. % or greater, about 3.5 wt. % or greater, about 4 wt. % or greater, about 4.5 wt. % or greater, about 5 wt. % or greater, about 5.5 wt. % or greater, about 6 wt. % or greater, about 6.5 wt. % or greater, about 7 wt. % or greater, about 7.5 wt. % or greater, about 8 wt. % or greater, about 8.5 wt. % or greater, about 9 wt. % or greater, or about 9.5 wt. % or greater. Additionally or alternatively, the reaction products may be disposed in the carrier fluid in an amount of about 10 wt. % or less, about 9.5 wt. % or less, about 9 wt. % or less, about 8.5 wt. % or less, about 8 wt. % or less, about 7.5 wt. % or less, about 7 wt. % or less, about 6.5 wt. % or less, about 6 wt. % or less, about 5.5 wt. % or less, about 5 wt. % or less, about 4.5 wt. % or less, about 4 wt. % or less, about 3.5 wt. % or less, about 3 wt. % or less, about 2.5 wt. % or less, about 2 wt. % or less, about 1.5 wt. % or less, about 1 wt. % or less, or about 0.5 wt. % or less. Suitable ranges for the one or more reaction products in the carrier fluid may include, for example, about 0.5 wt. % to about 10 wt. %, about 1 wt. % to about 9 wt. %, about 1.5 wt. % to about 8 wt. %, about 2 wt. % to about 7 wt. %, about 2.5 wt. % to about 6 wt. %, about 3 wt. % to about 5 wt. %, about 3.5 wt. % to about 4.5 wt. %, about 1 wt. % to about 5 wt. %, about 2 wt. % to about 4 wt. %, or about 0.1 wt. % to about 6.0 wt. %.

In any embodiment, the compositions of the present disclosure may be a drilling mud or a completion fluid, among others. Drilling muds may comprise an oil-based mud or a water-based mud as the carrier fluid. It is to be recognized that the term “oil-based” or “water-based” refers to the predominant continuous phase in the drilling mud. Specifically, an oil-based mud contains a hydrocarbon or “oil” continuous (external) phase, and a water-based mud contains an aqueous or “water” continuous (external) phase. The reaction products disclosed herein may be dissolved or emulsified in either type of base mud. In the case of an oil-based mud, the reaction products or other drilling mud components may be contained within a discontinuous (internal) phase comprising an aqueous liquid. In the case of a water-based mud, the reaction products or other drilling mud components may be contained within a discontinuous (internal) phase comprising an oleaginous (oily) liquid. Inversion of either type of emulsion may occur to release the reaction products for adsorption on a surface.

The reaction products may be combined with a drilling mud or other suitable carrier fluid prior to introducing the drilling mud into a wellbore, or the reaction products may be introduced to the drilling mud within the wellbore. In some instances, the reaction products may be combined with a first portion of the drilling mud to form a first drilling mud composition, and the first drilling mud composition may be combined with a second portion of drilling mud previously lacking the reaction products, wherein combining the first drilling mud composition and the second drilling mud composition may take place within a wellbore.

Oil-based muds may include a base oil and one or more base oil additives. Numerous base oils are known in the art. Particular base oils that may be useful in the present disclosure include natural oils and synthetic oils, as well as unconventional oils (or mixtures thereof), which can be used unrefined, refined, or re-refined (the latter is also known as reclaimed or reprocessed oil). Unrefined oils are those obtained directly from a natural or synthetic source and are used without added purification. These include shale oil obtained directly from retorting operations, petroleum oil obtained directly from primary distillation, and ester oil obtained directly from an esterification process. Refined oils are similar to the oils discussed for unrefined oils except refined oils are subjected to one or more purification steps to improve at least one base oil property, which will be familiar to one having ordinary skill in the art. Suitable purification processes may include solvent extraction, secondary distillation, acid extraction, base extraction, filtration, and percolation. Re-refined oils are obtained by processes analogous to refined oils but using an oil that has been previously used as a feed stock.

Groups I, II, III, IV, and V are broad lube base oil stock categories developed and defined by the American Petroleum Institute (API Publication 1509; www.API.org) to create guidelines for base oils. Group I base stocks have a viscosity index of 80 to 120 and contain >0.03% sulfur and/or less than 90% saturates. Group II base stocks have a viscosity index of 80 to 120, and contain ≤0.03% sulfur and ≥90% saturates. Group III stocks have a viscosity index <120 and contain ≤0.03% sulfur and >90% saturates. Group IV includes polyalphaolefins (PAO) and Gas-to-Liquid (GTL) materials. Group V base stock includes base stocks not included in Groups I-IV. Table 1 below summarizes properties of each of these five groups.

TABLE 1
Exemplary Base Oil Properties

| | Saturates | Sulfur | Viscosity Index |
|---|---|---|---|
| | (wt. %) | (wt. %) | (cSt) |
| Group I | <90 and/or | >0.03 and/or | 80 to 120 |
| Group II | ≥90 and | ≤0.03 and | 80 to 120 |
| Group III | ≥90 and | ≤0.03 and | ≥120 |

| | |
|---|---|
| Group IV | Includes PAOs and GTLs |
| Group V | All other base oil stocks not included in Groups I-IV |

Natural oils include animal oils, vegetable oils (castor oil and lard oil, for example), and mineral oils. Animal and vegetable oils possessing favorable thermal oxidative stability can be used. Mineral oils vary widely as to their crude source, for example, as to whether they are paraffinic, naphthenic, or mixed paraffinic-naphthenic. Oils derived from coal or shale are also useful. Natural oils vary also as to the method used for their production and purification, for example, their distillation range and whether they are straight run or cracked, hydrorefined, or solvent extracted. Group II and/or Group III hydroprocessed or hydrocracked basestocks, including synthetic oils, are also well known base oils.

Synthetic oils include hydrocarbon oil. Hydrocarbon oils include oils such as oligomerized, polymerized and interpolymerized olefins (polybutylenes, polypropylenes, propylene isobutylene copolymers, ethylene-olefin copolymers, and ethylene-alphaolefin copolymers, for example). Polyalphaolefin (PAO) oil base stocks are commonly used synthetic hydrocarbon oil. By way of example, PAOs derived from C₈ to C₁₄ olefins (e.g., C₈, C₁₀, C₁₂, C₁₄ olefins or mixtures thereof) may be utilized.

The number average molecular weights of the PAOs, which are known materials and generally available on a major commercial scale from suppliers such as ExxonMobil Chemical Company, Chevron Phillips Chemical Company, BP, and others, typically vary from 250 to 3,000 g/mol, with kinematic viscosities up to 3,500 cSt (100° C.). The PAOs are typically comprised of relatively low molecular weight hydrogenated polymers or oligomers of alphaolefins which include, but are not limited to, C₂ to C₃₂ alphaolefins such as poly-1-octene, poly-1-decene, poly-1-dodecene, mixtures thereof, and mixed olefin-derived polyolefins. However, dimers of higher olefins in the range of C₁₄ to C₁₈ may be used to provide low viscosity basestocks of acceptably low volatility. Depending on the viscosity grade and the starting oligomer, the PAOs may be predominantly trimers and/or tetramers of the starting olefins, with minor amounts of higher oligomers, having a kinematic viscosity range of 1.5 to 3,500 cSt (Kv100), such as from 1.5 to 12 cSt.

Other useful fluids for use as base oils include non-conventional or unconventional base stocks that have been processed, such as catalytically, or synthesized to provide high performance characteristics. Non-conventional or unconventional base oils include one or more of a mixture of base stock(s) derived from one or more Gas-to-Liquids (GTL) materials, as well as isomerate/isodewaxate base stock(s) derived from natural wax or waxy feeds, mineral and or non-mineral oil waxy feed stocks such as slack waxes, natural waxes, and waxy stocks such as gas oils, waxy fuels hydrocracker bottoms, waxy raffinate, hydrocrackate, thermal crackates, or other mineral, mineral oil, or even non-petroleum oil derived waxy materials such as waxy materials received from coal liquefaction or shale oil, and mixtures of such base stocks.

GTL materials are materials that are derived via one or more synthesis, combination, transformation, rearrangement, and/or degradation/deconstructive processes from gaseous carbon-containing compounds, hydrogen-containing compounds and/or elements as feed stocks such as hydrogen, carbon dioxide, carbon monoxide, water, methane, ethane, ethylene, acetylene, propane, propylene, propyne, butane, butylenes, and butynes. GTL base stocks and/or base oils are GTL materials of base oil viscosity that are generally derived from hydrocarbons; for example, waxy synthesized hydrocarbons, that are themselves derived from simpler gaseous carbon-containing compounds, hydrogen-containing compounds and/or elements as feed stocks. GTL base stock(s) and/or base oil(s) include oils boiling in the lube oil boiling range (1) separated/fractionated from synthesized GTL materials, such as, for example, by distillation and subsequently subjected to a final wax processing step, which involves either or both of a catalytic dewaxing process, or a solvent dewaxing process, to produce lube oils of reduced/low pour point; (2) synthesized wax isomerates, comprising, for example, hydrodewaxed or hydroisomerized cat and/or solvent dewaxed synthesized wax or waxy hydrocarbons; and (3) hydrodewaxed or hydroisomerized cat and/or solvent dewaxed Fischer-Tropsch (F-T) material (i.e., hydrocarbons, waxy hydrocarbons, waxes and possible analogous oxygenates), such as hydrodewaxed or hydroisomerized/followed by catalytic and/or solvent dewaxing, dewaxed F-T waxy hydrocarbons, or hydrodewaxed or hydroisomerized/followed by catalytic or solvent dewaxing, dewaxed F-T waxes, or mixtures thereof.

GTL base stock(s) and/or base oil(s) derived from GTL materials, especially, hydrodewaxed or hydroisomerized, followed by catalytic and/or solvent dewaxed wax or waxy feed, such as F-T material derived base stock(s) and/or base oil(s), are characterized typically as having kinematic viscosities at 100° C. of about 2 cSt to 50 cSt as measured by ASTM D445. They are further characterized typically as having pour points of about −5° C. to −40° C. or lower as measured by ASTM D97. They are also characterized typically as having viscosity indices of about 80 to 140 or greater as measured by ASTM D2270.

In addition, the GTL base stock(s) and/or base oil(s) are typically highly paraffinic (>90% saturates), and may contain mixtures of monocycloparaffins and multicycloparaffins in combination with non-cyclic isoparaffins. The ratio of the naphthenic (i.e., cycloparaffin) content in such combinations varies with the catalyst and temperature used. Further, GTL base stock(s) and/or base oil(s) typically have very low sulfur and nitrogen content, generally containing less than 10 ppm, and more typically less than 5 ppm of each of these elements. The sulfur and nitrogen content of GTL base stock(s) and/or base oil(s) obtained from F-T material, especially F-T wax, may be essentially nil. In addition, the absence of phosphorous and aromatics make this materially especially suitable for the formulation of low SAP products.

The term GTL base stock and/or base oil and/or wax isomerate base stock and/or base oil is to be understood as embracing individual fractions of such materials of wide viscosity range as recovered in the production process, mixtures of two or more of such fractions, as well as mixtures of one or two or more low viscosity fractions with one, two or more higher viscosity fractions to produce a blend wherein the blend exhibits a target kinematic viscosity.

The GTL material, from which the GTL base stock(s) and/or base oil(s) is/are derived may be an F-T material (i.e., hydrocarbons, waxy hydrocarbons, or wax). In addition, the GTL base stock(s) and/or base oil(s) are typically highly paraffinic (>90% saturates), and may contain mixtures of monocycloparaffins and multicycloparaffins in combination with non-cyclic isoparaffins. The ratio of the naphthenic (i.e., cycloparaffin) content in such combinations varies with the catalyst and temperature used. Further, GTL base stock(s) and/or base oil(s) and hydrodewaxed, or hydroisomerized/catalytic (and/or solvent) dewaxed base stock(s) and/or base oil(s) typically have very low sulfur and nitrogen content, generally containing less than 10 ppm, and more typically less than 5 ppm of each of these elements. The sulfur and nitrogen content of GTL base stock(s) and/or base oil(s) obtained from F-T material, especially F-T wax, may be essentially nil. In addition, the absence of phosphorous and aromatics make this material especially suitable for the formulation of low sulfur, sulfated ash, and phosphorus (low SAP) products.

Base oils for use in the formulated oil-based mud compositions useful in the present disclosure are any of the variety of oils corresponding to API Group I, Group II, Group III, Group IV, and Group V oils, and mixtures thereof, particularly API Group II, Group III, Group IV, and Group V oils, and mixtures thereof, due to their exceptional volatility, stability, viscometric and cleanliness features. Minor quantities of Group I stock, such as the amount used to dilute additives for blending into formulated lube oil products, can be tolerated in minimal amounts, such as their use as diluents/carrier oil for additives used on an “as-received” basis. Suitable Group II stocks may have a viscosity index in the range of 100 to 120.

Some base oils may have an ester content of about 50 wt. % or less, about 40 wt. % or less, about 30 wt. % or less, about 5 wt. % or less, or about 1 wt. % or less. Additionally or alternatively, some base oils may have an ester content of about 40 wt. % or greater, or about 50 wt. % or greater, about 70 wt. % or greater, or about 90 wt. % or greater.

Some base oils may have an aromatic content ranging from about 0.005 wt. % to about 15 wt. %, about 0.01 wt. % to about 10 wt. %, about 0.05 wt. % to about 5 wt. %, or about 0.1 wt. % to about 1 wt. %.

Some base oils have been characterized by their kinematic viscosity at 40° C. (Kv40). For example, particular base oils may have a kinematic viscosity of about 1.0 cSt or greater, about 1.3 cSt or greater, about 1.5 cSt or greater, about 1.7 cSt or greater, about 1.9 cSt or greater, about 2.1 cSt or greater, about 2.3 cSt or greater, about 2.5 cSt or greater, about 2.7 cSt or greater, about 2.9 cSt or greater, about 3.1 cSt or greater, about 3.3 cSt or greater, about 3.5 cSt or greater, about 3.7 cSt or greater, about 4.0 cSt or greater, about 4.5 cSt or greater, or about 4.8 cSt or greater at 40° C. Additionally or alternatively, the kinematic viscosity at 40° C. may be about 5.0 cSt or less, about 4.8 cSt or less, about 4.5 cSt or less, about 4.0 cSt or less, about 3.7 cSt or less, about 3.5 cSt or less, about 3.3 cSt or less, about 3.1 cSt or less, about 2.9 cSt or less, about 2.7 cSt or less, about 2.5 cSt or less, about 2.3 cSt or less, about 2.1 cSt or less, about 1.9 cSt or less, about 1.7 cSt or less, about 1.5 cSt or less, about 1.3 cSt or less, or about 1.1 cSt or less. Some such base oils are available from ExxonMobil Chemical Company under the tradename ESCAID™. ESCAID™ 110, for example, comprises a desulfurized hydrogenated hydrocarbon containing less than 0.50 wt. % aromatics and having a viscosity of about 1.7 cSt at 40° C. ESCAID™ 115, for example, has a viscosity of about 2.1 cSt at 40° C. ESCAID™ 120, for example, has a flash point above 100° C., and ESCAID™ 120 ULA has an aromatics content <0.01 wt. %.

Water-based muds may include an aqueous carrier fluid, such as fresh water, salt water, sea water, or brine, optionally containing a water-miscible organic co-solvent such as an alcohol or glycol. As used herein, the term “brine” refers to a saturated aqueous salt solution. Brines may increase the weight of a drilling mud composition, which can be advantageous for maintaining hydrostatic pressure in a wellbore. Illustrative weights may include a range of about 5 pounds per gallon (ppg) to about 20 ppg, or about 10 ppg to about 16 ppg. Suitable brines may include, for example, sodium chloride brines, sodium bromide brines, potassium chloride brines, potassium bromide brines, magnesium chloride brines, calcium chloride brines, and calcium bromide brines. Oil can also be emulsified in the aqueous carrier fluid in certain instances. Aqueous carrier fluids and water-based muds formed therefrom also may be free or essentially free from oil or oil components. Suitable emulsifying agents and/or surfactants may also be present.

Suitable water-based muds may include, for example, BARASHALE, HYDRO-GUARD, or PERFORMADRIL, which are available from Halliburton Energy Services, Inc.; PERFORMAX, PER-FLEX, TERRA-MAX, PYRO-DRILL, or MAX-BRIDGE, which are available from Baker-Hughes, Inc.; or DRILPEX, DURATHERM, ENVIROTHERM NT, KLA-SHIELD, or ULTRADRIL, which are available from Schlumberger.

Compositions of the present disclosure may also include further additives. The further additives may form a heterogeneous blend with a base oil or an aqueous carrier fluid. For either oil-based or water-based drilling mud compositions, the further additives may be dispersed in either the external phase or the internal phase of the drilling mud compositions. Additional additives that may be present include, but are not limited to, an acid, a base, a pH buffer, a viscosifier and/or a rheology modifier, an emulsifier, a wetting agent, a weighting agent, a fluid loss additive, and a friction reducer. Friction reducers may be solid friction reduction additives, liquid friction reduction additives, transitional friction reduction additives, or any combination thereof.

Illustrative pH buffers and bases may be selected from the group consisting of magnesium oxide, potassium hydroxide, calcium oxide, and calcium hydroxide. Lime is a commercially available example. The pH buffer or base can be present in a concentration in the range of about 0.5 to about 10.0 pounds per barrel (ppb) of the composition. The pH may range from a low of about 7, 8, 9, 10, 11, or 12 to a high of about 14, such as from 10 to 14.

Suitable viscosifiers and rheology modifiers may be selected from the group consisting of inorganic viscosifiers, fatty acids, including but not limited to dimer and trimer polycarboxylic fatty acids, diamines, polyamines, organophilic clays and combinations thereof. Commercially available examples of suitable viscosifiers include, but are not limited to, VG-PLUS™, available from M-I SWACO; and RHEMOD L™, TAU-MOD™, RM-63™, and combinations thereof, marketed by Halliburton Energy Services, Inc. The viscosifier and/or rheology modifier may be present in a concentration of at least 0.5 ppb of the compositions. Particularly suitable concentration ranges for the viscosifier and/or rheology modifier can include about 0.5 ppb to about 20 ppb, or about 0.5 ppb to about 10 ppb of the composition.

Suitable solid friction reduction additives that may be present in the compositions include a particulate material such as graphite. A suitable graphite may include a graphite such as STEELSEAL™, available from Halliburton Energy Services, Inc.

Suitable emulsifiers that may be present in the compositions can be selected from the group consisting of tall oil-based fatty acid derivatives such as amides, amines, amidoamines, and imidazolines made by reactions of fatty acids and various ethanolamine compounds, vegetable oil-based derivatives, and combinations thereof. Commercially available examples of suitable emulsifiers include, but are not limited to, EZ MUL™ NT, INVERMUL™ NT, LE SUPERMUL™, and combinations thereof, marketed by Halliburton Energy Services, Inc., and MEGAMUL™, VERSAMUL™, VERSACOAT™, and combinations thereof, marketed by MI-SWACO. The emulsifier may be present in at least a sufficient concentration such that the composition maintains a stable emulsion or an invert emulsion. Suitable concentrations may include a concentration of at least 1 ppb, including a particular concentration ranging from about 1 to about 20 ppb.

The compositions can further include a weighting agent. Suitable weighting agents can be selected from the group consisting of barite, hematite, manganese tetroxide, calcium carbonate, and combinations thereof. Commercially available examples of suitable weighting agents include, but are not limited to, BAROID™, BARACARB™, BARODENSE™, and combinations thereof, marketed by Halliburton Energy Services, Inc. and MICROMAX™, marketed by Elkem. The weighting agent may be present in a concentration of at least 10 ppb, including particular concentrations ranging from about 10 ppb to about 1000 ppb or about 10 ppb to about 800 ppb.

The drilling mud compositions can further include a fluid loss additive. Suitable fluid loss additives can be selected from the group consisting of oleophilic polymers, including crosslinked oleophilic polymers and particulates. Commercially available examples of suitable fluid loss additives include, but are not limited to, VERSATROL™, available from M-I SWACO; N-DRIL™ HT PLUS, and ADAPTA™, marketed by Halliburton Energy Services, Inc. The fluid loss additive can also be present in a concentration in the range of about 0.5 ppb to about 10 ppb of the compositions.

The compositions can further include an ester additive. The ester additive can be present in a concentration range of about 1 wt. % to about 20 wt. %.

The compositions may also optionally include one or more metal salts, MX′_{y}, where M is a Group 1 or Group 2 metal, X′ is a halogen, and y is 1 to 2. Exemplary metal salts include, but are not limited to, NaCl, KCl, CaCl₂, MgCl₂, and the like. The total amount of such salts in the compositions may range between about 10 wt. % to about 35 wt. % in the water phase. Organic additives that lower the water activity may also be used.

Water may also be present in the compositions, including within an oil-based mud, at any convenient concentration, typically at a relatively low concentration, such as about 0.5 wt. % to about 20 wt. %, about 0.5 wt. % to about 15 wt. %, about 0.5 wt. % to about 12.5 wt. %, about 0.5 wt. % to about 10 wt. %, about 0.5 wt. % to about 7.5 wt. %, about 0.5 wt. % to about 5 wt. %, about 0.5 wt. % to about 2.5 wt. %, about 0.5 wt. % to about 1 wt. %, about 1 wt. % to about 10 wt. %, about 1 wt. % to about 7.5 wt. %, about 1 wt. % to about 5 wt. %, about 1 wt. % to about 2.5 wt. %, about 2.5 wt. % to about 10 wt. %, about 2.5 wt. % to about 7.5 wt. %, about 2.5 wt. % to about 5 wt. %, about 5 wt. % to about 10 wt. %, or about 5 wt. % to about 7.5 wt. %. In water-based drilling muds, the water concentration may be higher, including about 50 wt. % or above, about 60 wt. % or above, about 70 wt. % or above, about 80 wt. % or above, or about 90 wt. % or above.

The compositions can further include wetting agents. Suitable wetting agents can be selected from the group consisting of tall oil-based fatty acid derivatives such as amides, amines, amidoamines, and imidazolines made by reactions of fatty acids and various ethanolamine compounds, vegetable oil-based derivatives, and combinations thereof. Commercially available examples of suitable wetting agents include, but are not limited to, DRILLTREAT™, OMC™, marketed by Halliburton Energy Services, Inc., and VERSAWET™, marketed by MI-SWACO. The wetting agent may be present in at least a sufficient concentration such that the composition maintains a stable emulsion or an invert emulsion. The wetting agent may be present in a concentration of at least 0.25 ppb of the compositions, including a concentration range of about 0.05 ppb to about 20 ppb. The compositions may also lack a wetting agent in some instances.

The compositions disclosed herein may include other liquid friction reduction additives. Other suitable liquid friction reduction additives may include, for example, amphiphilic compounds such as, for example, fatty acids, fatty acid esters, fatty acid amides, fatty alcohols, and fatty amines Illustrative examples may include, for example, oleic acid, oleyl amide, glycerol monooleate, and bis-(2-hydroxyethyl)alkylamines. Liquid friction reduction additives may be present in the compositions of the present disclosure in any suitable amount. In illustrative embodiments, the at least one liquid friction reduction additive may be present in an amount up to about 10 wt. %, or up to about 5 wt. %, or up to about 1 wt. %, or up to about 0.5 wt. %, or up to about 0.1 wt. %. Amounts both above and below the foregoing ranges, as well as any subrange thereof, are also contemplated by the present disclosure, which includes embodiments in which other liquid friction reduction additives are absent from the compositions disclosed herein.

Still other suitable liquid friction reduction additives may include, for example, nitrogen-containing compounds; esters; substituted imidazolines and amides, such as those described in U.S. Patent Application Publication 2017/0002252; hydrocarbyl diols containing C₁₀ to C₂₅ alkyl groups, such as those described in U.S. Patent Application Publication 2017/0002254; glycerol carbamates, such as those described in U.S. Patent Application Publication 2017/0002251; hydrocarbyl thioglycerols, such as those described in U.S. Patent Application Publication US 2017/0002250; phosphate esters and dihydrocarbyl hydrogen phosphites, such as those described in U.S. Patent Application Publication 2017/0002253; and hydrocarbyl aromatic compounds having at least one polar functional group, such as soluble alkylphenols. Commercially available liquid friction reduction additives that may be suitable for use in the embodiments of the present disclosure include, for example, VIKINOL™ 18, COLALUBE™ 3410, COLALUBE™ 3407, and additives under the tradename COLAMID™.

Methods of Making

The compositions described herein can be made by combining any of the one or more reaction products with a carrier fluid in a suitable amount, such as a carrier fluid comprising about 1 wt. % to about 95 wt. % water. The carrier fluid may comprise an oil-based drilling mud, a water-based drilling mud, or an aqueous completion fluid in particular instances. Suitable methods may additionally include mixing the carrier fluid with one or more additional components prior to combining with the one or more reaction products. Alternately, additional components may be combined with the carrier fluid after combining the one or more reaction products. Still further alternately, the one or more reaction products may be formed in situ within the carrier fluid in some instances.

Wellbore Methods

The compositions described herein may be useful in any number of wellbore methods, including drilling methods, completion methods, and the like. Exemplary methods may comprise providing a wellbore fluid comprising carrier fluid, such as at least one oil-based mud or water-based mud, and one or more reaction products combined with the carrier fluid, and introducing the wellbore fluid into a wellbore penetrating a subterranean formation.

The step of introducing may comprise pumping the wellbore fluid into the well. The pumping may be done continuously, i.e., providing a constant flow of wellbore fluid, periodically, or intermittently, i.e., alternating between periods of flow and no flow of the wellbore fluid. Particular methods may further include continuously, periodically, or intermittently providing a second amount of reaction products to the quantity of reaction products already provided to the well. In some methods, the continuous provision of the reaction products may provide an overall reduction in the amount of friction reducing additive used during the drilling process or other wellbore method. Alternatively, the continuous provision of the reaction products to the wellbore may allow a smoother drilling operation to take place. The well can be, without limitation, an oil, gas, or water production well, or an injection well. The methods may further include one or more steps of advancing a downhole tool in the well.

Within the wellbore, the wellbore fluids may be exposed to temperatures ranging from a low of about 70° C., 80° C., 90° C., 100° C., or 125° C. to a high of about 170° C., and pressures ranging from ambient pressure to a high of about 100 bar (10,000 kPa), 200 bar (20,000 kPa), 300 bar (30,000 kPa), 400 bar (40,000 kPa), 500 bar (50,000 kPa), or 600 bar (60,000 kPa). The wellbore fluids may be utilized when system components have rotation speed of about 1,000 rpm or less, including about 800 rpm or less, about 700 rpm or less, about 600 rpm or less and greater than 0 rpm. Also, the wellbore fluids may be with minimal rotation but instead longitudinal motion taking place at speeds of about 10,000 m/hr or less, including about 1,000 m/hr or less, or about 100 m/hr or less, or about 1 m/hr or less.

The well may penetrates a reservoir or is located adjacent to a reservoir. The methods can further include the step of removing at least a portion of the wellbore fluid after the step of introducing. The methods can include any number of additional optional steps. For example, some methods include one or more of the following optional steps: mounting and cementing of well pipes in the well; mounting of a blowout preventer or lubricator in the top of the well; drilling, at a distance from the well, a second well against a section of the first well to the effect that the second well comes into operational contact with the first well; mounting and cementing of well pipes in the second well; mounting of a blowout preventer or lubricator in the top of the second well; whereafter the drilling from one of the first or second well continues down into the reservoir and the other well which is not drilled to the reservoir is filled wholly or partially with a fluid and a drilling tool is placed in the other well and the other well is subsequently closed so that the other well can be accessed at a later point in time, and that the tool is left in the other well so that this tool can establish a connection to the one of the first or second wells into which the drilling continued.

Still other optional steps may include one or more of the following: calculating a desired path for a well of interest relative to a reference well; measuring a position of the well of interest relative to the reference well at a location along a wellbore of the well; calculating an actual path of the well of interest based at least in part on the measured position of the well of interest relative to the at least one reference well; comparing the actual path of the at least one well of interest to the desired path of the well of interest; and adjusting a drilling system to modify the actual path of the well of interest based at least in part on a deviation between the actual path of the well of interest and the desired path of the well of interest.

Any of the wellbore fluids described herein may be formulated in a variety of ways. Formulation may take place prior to introducing the wellbore fluid into a wellbore and/or within a wellbore itself. In certain embodiments, formulation of the wellbore fluids may occur during a drilling operation.

According to various embodiments, methods for forming a drilling mud may comprise providing at least one base drilling mud, and combining one or more reaction products with the at least one base drilling mud to produce a drilling mud composition with a coefficient of friction less than that of the at least one base drilling mud. The reaction products may be combined with the at least one base drilling mud before or during the course of drilling a wellbore using the drilling mud. In some embodiments, combining the plurality of particles with the at least one base drilling mud may comprise introducing the reaction products into the at least one base drilling mud within a wellbore. In such embodiments, a drilling operation may begin with a drilling mud composition lacking the reaction products, since frictional losses may be negligible early on during the drilling process (e.g., when the wellbore is shorter). After frictional losses become more significant, the reaction products may be introduced into the wellbore, where they may undergo mixing with the at least one base drilling mud and subsequently adsorb onto one or more surfaces to decrease friction. The reaction products may be introduced into the wellbore neat, or admixed with a suitable carrier fluid, such as a portion of the at least one base drilling mud or a base oil.

In any embodiment, the one or more reaction products may be blended with a quantity of the at least one base drilling mud (e.g., to form a concentrate), which may then be introduced into a wellbore to modify a larger quantity of base drilling mud therein. Combining the one or more reaction products with the at least one base drilling mud may comprise blending the reaction products with a first portion of the at least one base drilling mud to form a first drilling mud composition, and introducing the first drilling mud composition into a second portion of the at least one base drilling mud within the wellbore.

In any embodiment, the one or more reaction products may be blended with a quantity of base drilling mud to form a concentrate. Suitable blending techniques may include, for example, mixing, stirring, homogenization, and the like. The concentrate may then be blended with at least one base drilling mud, either within a wellbore or outside a wellbore, to form a drilling mud composition having a final concentration of reaction products within a specified range.

The reaction products may be present in a drilling mud of the present disclosure in an amount ranging between about 0.1 wt. % to about 20 wt. %, about 1 wt. % to about 15 wt. %, or about 5 wt. % to about 10 wt. %. All weight percentages are based on the total weight of the composition. Amounts of reaction products above 20 wt. % or below 0.1 wt. % are also contemplated by the present disclosure.

Compositions of the present disclosure have a coefficient of friction less than that of the at least one base drilling mud or other carrier fluid. Some drilling muds of the present disclosure may have a coefficient of friction of about 0.40 or less, about 0.30 or less, about 0.25 or less, about 0.20 or less, about 0.15 or less, about 0.10 or less, or about 0.05 or less. Additionally or alternatively, the coefficient of friction may be about 0.01 or more, about 0.03 or more, about 0.05 or more, about 0.10 or more, about 0.20 or more, about 0.25 or more, or about 0.30 or more. Ranges of the coefficient of friction of the compositions may include ranges of about 0.01 to about 0.40, about 0.05 to about 0.30, about 0.10 to about 0.25, or about 0.15 to about 0.20.

Additionally or alternatively, the compositions of the present disclosure may be characterized by a change in the coefficient of friction relative to the coefficient of friction of the carrier fluid without the reaction products being present. In other words, the compositions of the present disclosure may have a coefficient of friction that is about 5% or more less than, about 10% or more less than, about 15% or more less than, about 20% or more less than, about 25% or more less than, or about 30% or more less than, about 35% or more less than, about 40% or more less than, about 45% or more less than, about 50% or more less than, about 55% or more less than, or about 60% or more less than the coefficient of friction of the at least carrier fluid in the absence of the reaction products. Ranges over which the coefficient of friction may be reduced relative to the carrier fluid without the reaction products being present include ranges of about 5% to about 60% lower, about 10% to about 50% lower, about 15% to about 40% lower, about 20% to about 35% lower, or about 25% to about 30% lower.

Drilling mud compositions comprising the reaction products may be used in various drilling operations or in any other downhole operation in which reduced friction may be desirable. In addition to drilling operations, the compositions disclosed herein may also be used in completion operations or similar downhole operations. Drilling mud compositions of the present disclosure may be particularly useful in drilling operations having operational and/or mechanical constraints, such as in Extended Reach drilling operations. For example, certain drilling operations may be constrained due to torque limits at the drilling rig. The torque constraints may be due to maximum torque that a driver can deliver and/or the maximum torque that the drilling string can withstand before metal failure occurs. Such constraints are therefore different for different drilling rigs due to either the size of the driver and/or the drill string in use, as well as the actual conditions present in the wellbore. The term “Operating Torque” refers to the acceptable upper limit of torque in a drilling operation, taking into account a safety margin under the torque limit. The torque limit represents the torque value at which failure may occur. The Operating Torque can be measured by a dedicated device (e.g., a torque sub) and/or by measured power usage of the driver. Drilling operations may be conducted with at least a 10% safety margin between the Operating Torque and the torque limit. When the Operating Torque is nearing or exceeding what is considered to be a reasonable safety margin, the length of the wellbore may be limited until corrective action can be taken to alleviate the excess torque. Operating changes that can be performed to reduce the Operating Torque include, for example, reducing the rate of penetration (the forward rate of drilling), removing accumulated cuttings from the wellbore, removing the drill string from the wellbore and replacing/refurbishing worn components, and/or reducing the amount of low gravity solids (ground down cuttings) from the circulating drilling mud composition. These steps to reduce the Operating Torque can be expensive and time consuming, and may offer little benefit. Therefore, the addition of the reaction products described herein to a drilling mud may be beneficial to reduce the Operating Torque to facilitate a drilling operation, such as to increase the rate of penetration and/or to allow for a wellbore of greater length to be drilled.

The drilling mud compositions described herein may be formulated prior to or during the course of conducting a drilling operation, as referenced in brief above. In some embodiments, the drilling mud compositions of the present disclosure may be formulated by combining at least one base drilling mud, the reaction products, and any optional additives outside the wellbore, and the drilling mud composition may be introduced into the wellbore in a completely formulated or near-completely formulated state. In other embodiments, the reaction products may be combined with a base drilling mud within the wellbore. Optional additives may be introduced to the base drilling mud in combination with the reaction products, or separately from the reaction products, either before or after combining the reaction products with the base drilling mud. Optional additives may already be present in the at least one base drilling mud before the reaction products are combined therewith as well.

The reaction products may be introduced neat into the at least one base drilling mud within the wellbore. Alternately, the reaction products may be introduced in fluid form into the at least one base drilling mud within the wellbore. More specifically, the reaction products may be combined with a first portion of the at least one base drilling mud to form a first drilling mud composition (e.g., a concentrate comprising the reaction products), and the first drilling mud composition may be introduced into a second portion of the at least one base drilling mud within the wellbore to complete the formulation of the drilling mud composition. Optionally, the first drilling mud composition may be formulated at an off-site location and be transferred to a wellbore for introduction thereto.

Methods of the present disclosure may further comprise extending the wellbore by drilling in the presence of the reaction products. Benefits of extending the wellbore in the presence of the reaction products may include, for example, decreasing friction during rotation of the drill string and/or reducing Operating Torque. The drilling mud compositions of the present disclosure may be used from the outset of a drilling operation, or they may be used in a drilling operation in response to reaching operational and/or mechanical limits, such as Operating Torque or torque limits. That is, in some embodiments, an unmodified drilling mud composition may be used to conduct a first part of the drilling operation, and a drilling mud composition of the present disclosure may be used to conduct a second portion of the drilling operation. The methods may comprise determining a torque limit for the drilling operation, and optionally setting the Operating Torque. In some embodiments, the reaction products may be introduced into the wellbore when the Operating Torque of the drilling operation is about 90% of the torque limit or greater, about 95% of the torque limit or greater, or about 99% of the torque limit or greater.

Introducing the reaction products of the present disclosure into a wellbore during a drilling operation may comprise blending the reaction products and at least one base drilling mud to form a first drilling mud composition, and introducing the first drilling mud composition into the wellbore. Introducing the first drilling mud composition into the wellbore can comprise pumping the first drilling mud composition into the wellbore. The pumping may be performed continuously (i.e., providing a constant or variable flow of the first drilling mud composition at all times), periodically, or intermittently (i.e., alternating between periods of flow and no flow of the first drilling mud composition). Particular methods may further include continuously, periodically, or intermittently providing a second amount of the reaction products to the first drilling mud composition already provided to the well (e.g., to replace adsorptive or degradative loss of the reaction products). Continuous provision of the reaction products or a first drilling mud composition formed therefrom may provide an overall reduction in the amount of reaction products used during the drilling operation. Alternatively, continuous provision of the reaction products or a first drilling mud composition formed therefrom may allow smoother drilling to take place during the drilling operation. The wellbore can be, without limitation, an oil, gas, or water production well, or an injection well. The wellbore may penetrate a reservoir or be located adjacent to a reservoir.

The drilling operations can include any number of additional optional steps. In some embodiments, the drilling operations can further include the step of removing at least a portion of the at least one drilling mud composition from the wellbore after introduction thereof. Some drilling operations may include one or more of the following optional steps: mounting and cementing of well pipes; mounting a blowout preventer or lubricator in the top of the well; drilling, at a distance from the well, a second well against a section of a first well to the effect that the second well achieves operational contact with the first well; mounting and cementing of well pipes in the second well; mounting a blowout preventer or lubricator in the top of the second well; whereafter the drilling from one of the first or second well continues down into the reservoir and the other well which is not drilled to the reservoir is filled wholly or partially with a fluid and a drilling tool is placed in the other well and the other well is subsequently closed so that the other well can be accessed at a later point in time, and that the tool is left in the other well so that this tool can establish a connection to the one of the first or second wells into which the drilling continued.

Still other optional steps in a drilling operation may include one or more of the following: calculating a desired path for a well of interest relative to a reference well; measuring a position of the well of interest relative to the reference well at a location along the wellbore; calculating an actual path of the well of interest based at least in part on the measured position of the well of interest relative to the at least one reference well; comparing the actual path of the at least one well of interest to the desired path of the well of interest; and adjusting a drilling system to modify the actual path of the well of interest based at least in part on a deviation between the actual path of the well of interest and the desired path of the well of interest.

Methods of the present disclosure may further include one or more steps of advancing a downhole tool in the wellbore. Suitable wellbore tools are not considered to be particularly limited and will be familiar to one having ordinary skill in the art.

Methods of the present disclosure may employ the reaction products described herein to reduce the Operating Torque in a given drilling operation. The reaction products may be employed to reduce the Operating Torque of the drilling operation when the Operating Torque has reached a threshold level, such as about 90% of the torque limit or greater, about 95% of the torque limit or greater, or about 99% of the torque limit or greater. The drilling mud compositions of the present disclosure may reduce the Operating Torque of the drilling operation by at least about 1%, by at least about 2%, by at least about 3%, by at least about 5%, or by at least about 10%. Accordingly, the drilling mud compositions of the present disclosure may allow the drilling operation to be conducted with an Operating Torque of about 99% or less, about 98% or less, about 97% or less, about 95% or less, or about 90% or less of the Operating Torque of the same drilling operation performed with a comparable drilling mud composition lacking the reaction products, such as the base drilling mud.

Embodiments disclosed herein include:

Embodiment 1. A composition comprising one or more reaction products, the one or more reaction products being formable from

a) reacting Component 1 and Component 2 in the presence of a base

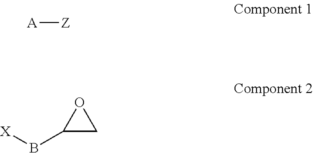

thereby allowing the formation of one or more initial reaction products comprising at least Component A;

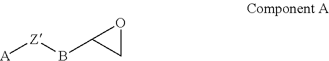

wherein A and B are independently branched or unbranched, cyclic or acyclic, substituted or unsubstituted, saturated or unsaturated C₁-C₁₀₀ hydrocarbyl groups;
wherein Z is a nucleophilic group selected from the group consisting of OH, SH and NH₂, and
X is a leaving group displaceable by the nucleophilic group; and
b) adding an acid and water to said one or more initial reaction products, wherein the acid is selected from the group consisting of a sulfonic acid, a sulfinic acid, a phosphonic acid, a phosphinic acid, and any combination thereof, thereby obtaining said one or more reaction products;
wherein the one or more reaction products comprise Component B, Component C, or a combination thereof

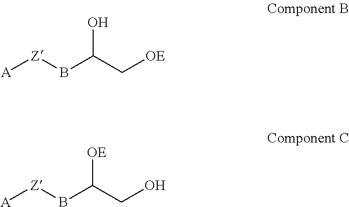

wherein E is H, —SO₂R¹, —SOR², —PR³O(OH), —POR⁴R⁵, wherein R¹, R², R³, R⁴, R⁵ independently are a branched or unbranched, cyclic or acyclic, substituted or unsubstituted, saturated or unsaturated C₁-C₁₀₀ hydrocarbyl group.

Embodiment 2. The composition of Embodiment 1, wherein the one or more reaction products further comprise an oligomer formable from Component A, an oligomer formable from Component B, an oligomer formable from Component C, or any combination thereof.

Embodiment 3. The composition of Embodiment 2, wherein the oligomer formable from Component A is formable from a nucleophilic epoxide ring opening reaction between Component 1 and Component A, between Component B and Component A, between Component C and Component A, or a combination thereof.

Embodiment 4. The composition of any one of Embodiments 1 to 3, wherein
A is a branched or unbranched, cyclic or acyclic, substituted or unsubstituted, saturated or unsaturated C₁-C₄₀ hydrocarbyl group; and
B is C₁-05 alkyl, preferably methyl.

Embodiment 5. The composition of any one of Embodiments 1 to 4, wherein A is unbranched, acyclic, and unsubstituted.

Embodiment 6. The composition of any one of Embodiments 1 to 5, wherein Component 2 is epichlorohydrin or epibromohydrin, preferably epichlorohydrin.

Embodiment 7. The composition of any one of Embodiments 1 to 6, wherein Z is hydroxyl (OH).

Embodiment 8. A composition comprising:

one or more reaction products, the one or more reaction products being formable from a reaction mixture comprising Component 2′; water; an acid selected from the group consisting of a sulfonic acid, a sulfinic acid, a phosphonic acid, a phosphinic acid, and any combination thereof; and water;

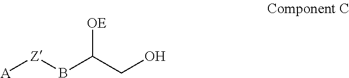

wherein D is selected from the group consisting of a branched or unbranched, cyclic or acyclic, substituted or unsubstituted, saturated or unsaturated C₁-C₁₀₀ hydrocarbyl group; thereby obtaining said one or more reaction products; wherein the one or more reaction products comprise Component X, Component Y, or a combination thereof

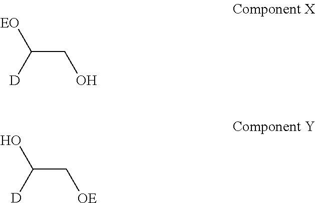

wherein E is —SO₂R¹, —SOR², —PR³O(OH), —POR⁴R⁵, wherein R¹, R², R³, R⁴, and R⁵ independently are a branched or unbranched, cyclic or acyclic, substituted or unsubstituted, saturated or unsaturated C₁-C₁₀₀ hydrocarbyl group.

Embodiment 9. The composition of Embodiments 8, wherein D is selected from the group consisting of a branched or unbranched, cyclic or acyclic, substituted or unsubstituted, saturated or unsaturated C₁-C₄₀ hydrocarbyl group.

Embodiment 10. The composition of Embodiment 9, wherein D is unbranched, acyclic, and unsubstituted.

Embodiment 11. The composition of any one of Embodiments 8 to 10, wherein said one or more reaction products further comprise at least one oligomer selected from an oligomer formable from Component X, an oligomer formable from Component Y, or a combination thereof.

Embodiment 12. The composition of Embodiment 11, wherein the at least one oligomer contains at least one oligomer formable from:
a nucleophilic epoxide ring opening reaction between Component D and Component X; and
a nucleophilic epoxide ring opening reaction between Component D and Component Y.

Embodiment 13. The composition of any one of Embodiments 1 to 12, wherein R¹, R², R³, R⁴, and R⁵ independently are C₁-C₅ alkyl or C₆₋₁₀aryl, preferably C₁-C₅ alkyl.

Embodiment 14. The composition of any one of Embodiment 13, wherein R¹, R², R³, R⁴, and R⁵ are methyl.

Embodiment 15. The composition of any one of Embodiments 1 to 14, wherein the acid is a sulfonic acid and E is —SO₂R¹.

Embodiment 16. The composition of Embodiment 15, wherein the sulfonic acid is a C₁-C₅alkylsulfonic acid, and R¹ is C₁-C₅alkyl; preferably wherein the sulfonic acid is methylsulfonic acid and IV is methyl.

Embodiment 17. A composition comprising:

one or more reaction products, the one or more reaction products being formable from
a) reacting Component 1 and Component 2 the presence of a base;

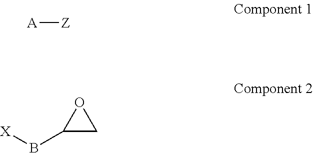

thereby allowing the formation of one or more initial reaction products comprising at least Component A;

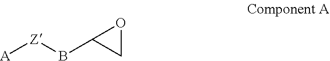

wherein A and B are independently branched or unbranched, cyclic or acyclic, substituted or unsubstituted, saturated or unsaturated C₁-C₁₀₀ hydrocarbyl groups;
wherein Z is a nucleophilic group selected from the group consisting of OH, SH and NH₂; Z′ is selected from the group consisting of 0, S and NH; and X is a leaving group displaceable by the nucleophilic group;
and
b) adding a mineral acid and water to said one or more initial reaction products; thereby obtaining said one or more reaction products, wherein the one or more reaction products optionally comprise Component A′

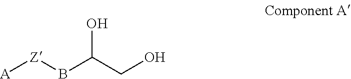

and wherein the one or more reaction products comprise at least one oligomer differing from Component A′ and selected from the group consisting of at least one oligomer formable from Component A, at least one oligomer formable from Component A′, at least one oligomer formable from Component 2, and any combination thereof.

Embodiment 18. The composition of Embodiment 17, wherein the oligomer formable from Component A′ is formable from a nucleophilic epoxide ring-opening reaction between Component A′ and Component A; a nucleophilic epoxide ring-opening reaction between Component A′ and Component 2, a nucleophilic coupling reaction between Component A′ and Component 2, or any combination thereof.

Embodiment 19. The composition of Embodiment 17 or 18, wherein the oligomer formable from Component A is formable from a nucleophilic epoxide ring-opening reaction between Component A and Component 1, optionally followed by a nucleophilic epoxide ring-opening reaction with Component 2, or a nucleophilic coupling reaction with Component 2, or any combination thereof.

Embodiment 20. The composition of any one of Embodiments 17 to 19, wherein
A is a branched or unbranched, cyclic or acyclic, substituted or unsubstituted, saturated or unsaturated C₁-C₄₀ hydrocarbyl group; and
B is C₁-05 alkyl.

Embodiment 21. The composition of any one of Embodiments 17 to 20, wherein Component 2 is epichlorohydrin or epibromohydrin, preferably epichlorohydrin.

Embodiment 22. The composition of any one of Embodiments 17 to 21, wherein Z is hydroxyl (OH).

Embodiment 23. The composition of any one of Embodiments 1 to 7, or 17 to 22 wherein Component 1 and Component 2 are provided in a molar ratio from 2:1 to 1:2.

Embodiment 24. The composition of any one of Embodiments 1 to 23, wherein said one or more reaction products form at least 1 wt % of said composition.

Embodiment 25. The composition of any one of Embodiments 1 to 24, wherein said one or more reaction products form at least 10 wt % of said composition.

Embodiment 26. The composition of any one of Embodiments 1 to 24, further comprising: a carrier fluid, the composition comprising about 90 wt. % to about 99 wt. % of the carrier fluid, and about 1 wt. % to about 10 wt. % of the one or more reaction products.

Embodiment 27. The composition of Embodiment 10, wherein the carrier fluid comprises an oil-based drilling mud, a water-based drilling mud, or an aqueous completion fluid.

Embodiment 28. A method comprising:

combining one or more reaction products with a carrier fluid to form a composition having lubricant properties, the one or more reaction products being formable as defined in any one of Embodiments 1 to 23.

Embodiment 29. The method of Embodiment 28, wherein the composition comprises about 90 wt. % to about 99 wt. % of the carrier fluid, and about 1 wt. % to about 10 wt. % of the one or more reaction products.

Embodiment 30. A downhole method comprising: providing a wellbore fluid comprising a carrier fluid and one or more reaction products combined with the carrier fluid, the one or more reaction products being formable as defined in any one of Embodiments 1 to 23.

Embodiment 31. The downhole method of Embodiment 30, further comprising extending and/or completing the wellbore in the presence of the wellbore fluid.

To facilitate a better understanding of the disclosure herein, the following examples of various representative embodiments are given. In no way should the following examples be read to limit, or to define, the scope of the present disclosure.

### EXAMPLES

Example 1A: Oligomerization of Oleyl Alcohol and Epichlorohydrin without Added Acid. 1:1 molar quantities of oleyl alcohol and epichlorohydrin were combined in water with an amount of sodium hydroxide in 50% molar excess with respect to epichlorohydrin and allowed to react for until <1% epichlorohydrin remained. After the reaction time, the product distribution was analyzed by gel permeation chromatography. Table 2 shows the resulting product distribution and normalized product masses. Normalized mass represents the mass of each identified peak compared to the weight of the first eluted peak.

TABLE 2

| | % of Total | Normalized |
|---|---|---|
| GPC Peak | Molecules | Mass |
| A | 63.2 | 1 |
| B | 18.6 | 2 |
| C | 9.4 | 3 |
| D | 4.2 | 5 |
| E | 4.5 | 7 |

As shown, oligomerization occurred even without an added acid to promote hydrolytic opening of the epoxide ring.

Example 1B: Oligomerization of Oleyl Alcohol and Epichlorohydrin with Added Aqueous Sulfuric Acid. Example 1A was repeated, except aqueous sulfuric acid was added to the product mixture to promote hydrolytic opening of the epoxide ring, after isolating the initial reaction products. Table 3 shows the resulting product distribution and normalized product masses.

TABLE 3

| | % of Total | Normalized |
|---|---|---|
| GPC Peak | Molecules | Mass |
| A | 4.3 | 1 |
| B | 40.7 | 2 |
| C | 25.6 | 3 |
| D | 25.9 | 5 |
| E | 4 | 7 |

As shown, there was an increased propensity toward formation of higher oligomers when the sulfuric acid was present.

Example 1C: Oligomerization of Oleyl Alcohol and Epichlorohydrin with Added Aqueous Methanesulfonic Acid. Example 1B was repeated, except substituting aqueous methanesulfonic acid for sulfuric acid to promote hydrolytic opening of the epoxide ring. Table 4 shows the resulting product distribution and normalized product masses.

TABLE 4

| | % of Total | Normalized |
|---|---|---|
| GPC Peak | Molecules | Mass |
| A | 23.2 | 1 |
| B | 33.2 | 2 |
| C | 24.4 | 3 |
| D | 10.0 | 5 |
| E | 9.2 | 7 |

Again, there was an increased propensity toward formation of higher oligomers when the methanesulfonic acid was present. Additionally, ˜25% of the reaction products incorporated at least one methanesulfonate substituent.

Example 2: Friction Reduction Properties. Coefficient of Friction (CoF) was determined using a Falex Block-on-Ring machine. The block was made of SAE 01 tool steel and the ring was made of SAE 4620 carbon steel. The block had a length of 15.76 mm (0.620 in.) and a width of 6.35 mm (0.250 in.). The ring had an outer diameter of 35 mm (1.377 in.) and a width of 8.15 mm (0.321 in.). The block had a surface roughness, Rₐ, ranging from 0.10 μm to 0.20 μm. The ring had a surface roughness, Rₐ, ranging from 0.15 μm to 0.30 μm. A new block and ring pair was used for each test.

For each sample tested, a mixture was prepared with the plurality of reaction products disposed in an oil-based drilling mud. A desired amount of each additive was weighed, transferred to the formulated mud system, and mixed via high-shear mixing. Each sample was loaded into the testing cell of the Falex Block-on-Ring machine that was pre-loaded with a new pair of block and ring at each test. The interface between the block and the ring was fully emerged in the drilling mud composition.

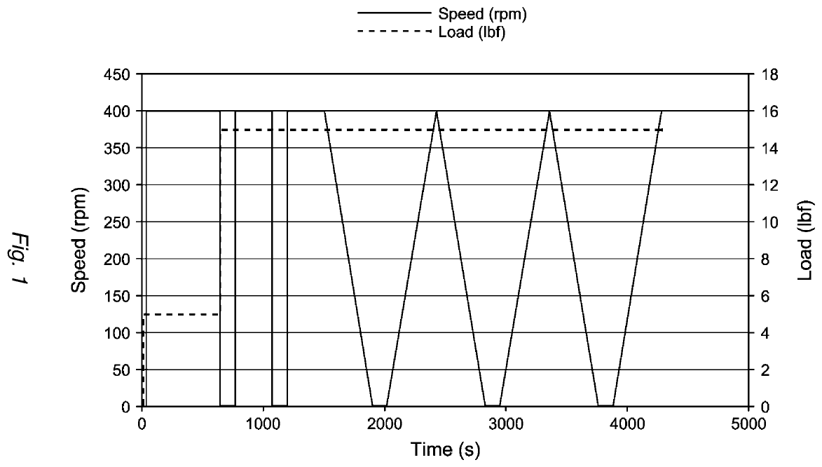

Each test commenced with an initial running-in period with a ring rotation speed of 400 rpm, during which the load of the block applied to the ring was gradually increased from 0 to 5 lbf and then from 5 to 15 lbf while the system was warmed from ambient temperature to 75° C. A series of three ramping cycles were then performed consisting of a ramping-down step followed by a ramping-up step. During each ramping-down step, the ring rotation speed was decreased from 400 to 0 rpm at 1 rpm/s, and during each ramping-up step the ring rotation speed was increased from 0 rpm to 400 rpm at 1 rpm/s. During some of these transitions, the rotation of the ring was stopped for 2 minutes to allow system relaxation. COF vs. rpm relationships obtained during the ramping-up steps were quantitatively similar to that obtained during the ramping-down steps. The COF vs. rpm relationships obtained during the three ramping-down steps were averaged to obtain the reported COF vs. rpm relationship. In some instances, a given friction-reducing composition was tested multiple times, in which case the average value is reported. The testing protocol schematically shown in FIG. 1.

Friction reduction performance for several reaction products in comparison to various long-chain alcohols is summarized in Table 5 below.

TABLE 5

| | Coefficient | % Reduction of |
|---|---|---|
| Friction Reduction | of Friction | Coefficient of |
| Component | @ 30 rpm | Friction @ 30 rpm |
| Oleyl alcohol | 0.249 ± 0.008 | 7.8 |
| Stearyl alcohol | 0.224 | 17 |
| Example 1B reaction product | 0.172 | 23.6 |

Example 3: Adsorption Isotherms. The adsorption isotherms for the reaction products of Example 1B and Example 1C were measured upon an iron surface. Testing was conducted by exposing the reaction products to iron particles in a drilling mud carrier fluid, such as E110, allowing the reaction products to adsorb onto the iron particles, centrifuging, and measuring the concentration of the remaining reaction product within the carrier fluid. Adsorption parameters such as free energy of adsorption (−ΔG°) and maximum adsorption capacities (qₘₐₓ) were calculated using a Langmuir adsorption model. Lubricity measurements were also performed to examine the correlation between lubricity and adsorption.

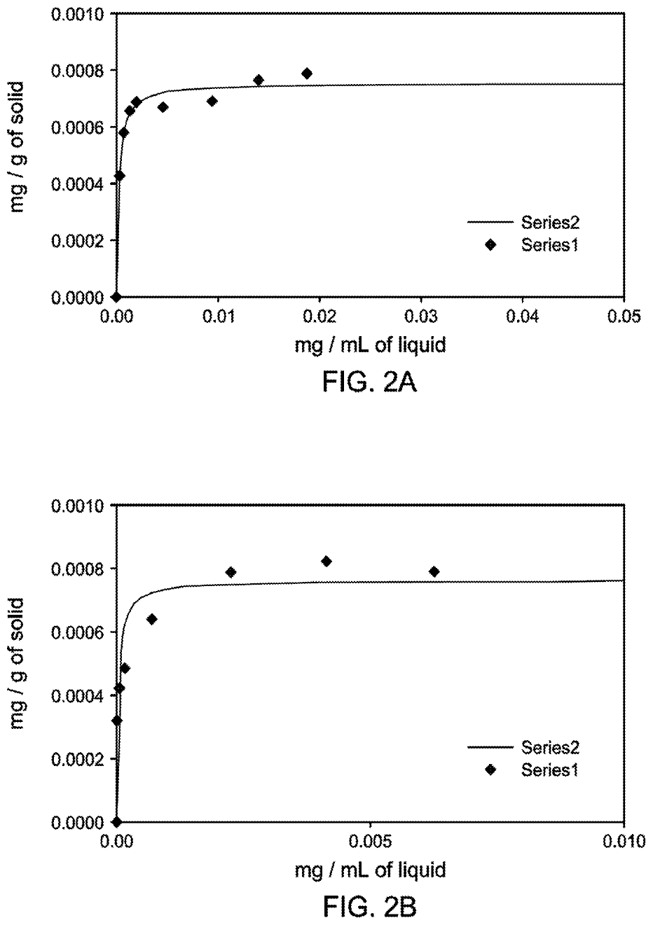

FIGS. 2A and 2B show adsorption isotherms upon iron for the reaction products of Examples 1B and 1C, respectively. Two samples of each were produced and tested under various reaction conditions. As shown, the sulfonated reaction product of Example 1C (FIG. 2B) exhibited a greater free energy of adsorption. The adsorption capacity per mole was similar to molecules lacking the sulfonate groups, even though there was approximately a three times higher concentration of sulfonate-free reaction products. This result suggests that reaction products containing a sulfonate group are more resistant to desorption. Table 6 below summarizes the free energy of adsorption and capacity of the reaction products in E110 carrier fluids.

TABLE 6

| Friction Reduction | Free Energy of | Capacity |
|---|---|---|
| Component | Adsorption (kJ/mol) | (mmol/g) |
| Example 1B | −19.6 | 0.0013 |
| Reaction Product | | |
| (Sample 1) | | |
| Example 1B | −19.6 | 0.0011 |
| Reaction Product | | |
| (Sample 2) | | |
| Example 1C | −22.2 | 0.0007 |
| Sulfonate-Free | | |
| Portion of Reaction | | |
| Product (Sample 1) | | |
| Example 1C | −26.6 | 0.0006 |
| Sulfonated Portion | | |
| of Reaction Product | | |
| (Sample 1) | | |
| Example 1C | −20.8 | 0.0008 |
| Sulfonate-Free | | |
| Portion of Reaction | | |
| Product (Sample 2) | | |
| Example 1C-2 | −27.5 | 0.0007 |
| Sulfonated Portion | | |
| of Reaction Product | | |
| (Sample 2) | | |

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. A composition comprising one or more reaction products, the one or more reaction products being formable from
a) reacting Component 1 and Component 2 in the presence of a base 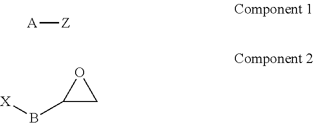
thereby allowing the formation of one or more initial reaction products comprising at least Component A; 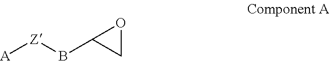
wherein A and B are independently branched or unbranched, cyclic or acyclic, substituted or unsubstituted, saturated or unsaturated C₁-C₁₀₀ hydrocarbyl groups;
wherein Z is a nucleophilic group selected from the group consisting of OH, SH and NH₂, and X is a leaving group displaceable by the nucleophilic group; and
b) adding an acid and water to said one or more initial reaction products, wherein the acid is selected from the group consisting of a sulfonic acid, a sulfinic acid, a phosphonic acid, a phosphinic acid, and any combination thereof, thereby obtaining said one or more reaction products;
wherein the one or more reaction products comprise Component B, Component C, or a combination thereof 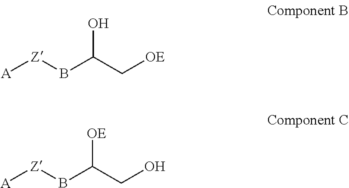
wherein E is H, —SO₂R¹, —SOR², —PR³O(OH), —POR⁴R⁵, wherein R¹, R², R³, R⁴, R⁵ independently are a branched or unbranched, cyclic or acyclic, substituted or unsubstituted, saturated or unsaturated C₁-C₁₀₀ hydrocarbyl group.

2. The composition of claim 1, wherein the one or more reaction products further comprise an oligomer formable from Component A, an oligomer formable from Component B, an oligomer formable from Component C, or any combination thereof.

3. The composition of claim 2, wherein the oligomer formable from Component A is formable from a nucleophilic epoxide ring opening reaction between Component 1 and Component A.

4. A composition comprising:
one or more reaction products, the one or more reaction products being formable from a reaction mixture comprising Component 2′; water; an acid selected from the group consisting of a sulfonic acid, a sulfinic acid, a phosphonic acid, a phosphinic acid, and any combination thereof and water; 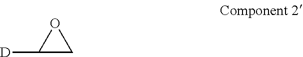
wherein D is selected from the group consisting of a branched or unbranched, cyclic or acyclic, substituted or unsubstituted, saturated or unsaturated C₁-C₁₀₀ hydrocarbyl group;
thereby obtaining said one or more reaction products; wherein the one or more reaction products comprise Component X, Component Y, or a combination thereof 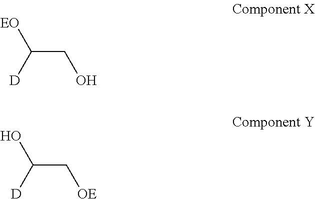
wherein E is —SO₂R¹, —SOR², —PR³O(OH), —POR⁴R⁵, wherein R¹, R², R³, R⁴, R⁵ independently are a branched or unbranched, cyclic or acyclic, substituted or unsubstituted, saturated or unsaturated C₁-C₁₀₀ hydrocarbyl group.

5. The composition of claim 4, wherein said one or more reaction products further comprise at least one oligomer selected from an oligomer formable from Component X, an oligomer formable from Component Y, or a combination thereof.

6. The composition of claim 1, wherein R¹, R², R³, R⁴, R⁵ are a methyl group.

7. A composition comprising:
one or more reaction products, the one or more reaction products being formable from
a) reacting Component 1 and Component 2 the presence of a base; 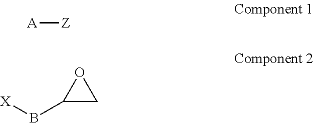
thereby allowing the formation of one or more initial reaction products comprising at least Component A; 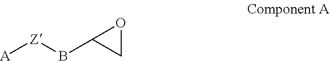
wherein A and B are independently branched or unbranched, cyclic or acyclic, substituted or unsubstituted, saturated or unsaturated C₁-C₁₀₀ hydrocarbyl groups;
wherein Z is a nucleophilic group selected from the group consisting of OH, SH and NH₂; Z′ is selected from the group consisting of O, S and NH; and X is a leaving group displaceable by the nucleophilic group;
and
b) adding a mineral acid and water to said one or more initial reaction products; thereby obtaining said one or more reaction products, wherein the one or more reaction products optionally comprise Component A′ 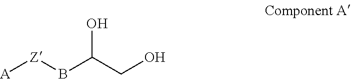
and wherein the one or more reaction products comprise at least one oligomer differing from Component A′ and selected from the group consisting of at least one oligomer formable from Component A, at least one oligomer formable from Component A′, at least one oligomer formable from Component 2, and any combination thereof.

8. The composition of claim 7, wherein the oligomer formable from Component A′ is formable from a nucleophilic epoxide ring-opening reaction between Component A′ and Component 2, a nucleophilic coupling reaction between Component A′ and Component 2, or any combination thereof.

9. The composition of claim 7, wherein the oligomer formable from Component A is formable from a nucleophilic epoxide ring-opening reaction between Component A and Component 1, optionally followed by a nucleophilic epoxide ring-opening reaction with Component 2, or a nucleophilic coupling reaction with Component 2, or any combination thereof.

10. The composition of claim 1, further comprising:
a carrier fluid, the composition comprising about 90 wt. % to about 99 wt. % of the carrier fluid, and about 1 wt. % to about 10 wt. % of the one or more reaction products.

11. The composition of claim 10, wherein the carrier fluid comprises an oil-based drilling mud, a water-based drilling mud, or an aqueous completion fluid.

12. A method comprising:
combining one or more reaction products with a carrier fluid to form a composition having lubricant properties, the one or more reaction products being formable from
a) reacting Component 1 and Component 2 in the presence of a base 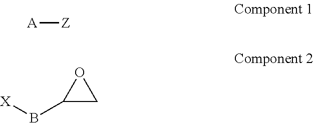
thereby allowing the formation of one or more initial reaction products comprising at least Component A; 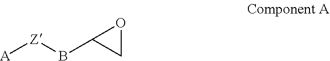
wherein A and B are independently branched or unbranched, cyclic or acyclic, substituted or unsubstituted, saturated or unsaturated C₁-C₁₀₀ hydrocarbyl groups;
wherein Z is a nucleophilic group selected from the group consisting of OH, SH and NH₂, and X is a leaving group displaceable by the nucleophilic group; and
b) adding an acid and water to said one or more initial reaction products, wherein the acid is selected from the group consisting of a sulfonic acid, a sulfinic acid, a phosphonic acid, a phosphinic acid, and any combination thereof, thereby obtaining said one or more reaction products;
wherein the one or more reaction products comprise Component B, Component C, or a combination thereof 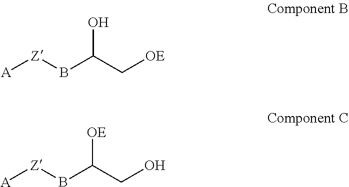
wherein E is H, —SO₂R¹, —SOR², —PR³O(OH), —POR⁴R⁵, wherein R¹, R², R³, R⁴, R⁵ independently are a branched or unbranched, cyclic or acyclic, substituted or unsubstituted, saturated or unsaturated C₁-C₁₀₀ hydrocarbyl group.

13-14. (canceled)

15. The method of claim 12, wherein the composition comprises about 90 wt. % to about 99 wt. % of the carrier fluid, and about 1 wt. % to about 10 wt. % of the one or more reaction products.

16. A downhole method comprising:
providing a wellbore fluid comprising a carrier fluid and one or more reaction products combined with the carrier fluid, the one or more reaction products being formable from
a) reacting Component 1 and Component 2 in the presence of a base 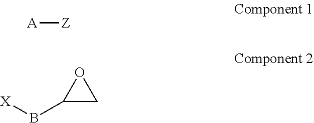
thereby allowing the formation of one or more initial reaction products comprising at least Component A; 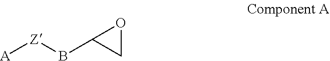
wherein A and B are independently branched or unbranched, cyclic or acyclic, substituted or unsubstituted, saturated or unsaturated C₁-C₁₀₀ hydrocarbyl groups;
wherein Z is a nucleophilic group selected from the group consisting of OH, SH and NH₂, and X is a leaving group displaceable by the nucleophilic group; and
b) adding an acid and water to said one or more initial reaction products, wherein the acid is selected from the group consisting of a sulfonic acid, a sulfinic acid, a phosphonic acid, a phosphinic acid, and any combination thereof, thereby obtaining said one or more reaction products;
wherein the one or more reaction products comprise Component B, Component C, or a combination thereof 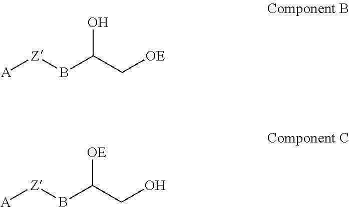
wherein E is H, —SO₂R¹, —SOR², —PR³O(OH), —POR⁴R⁵, wherein R¹, R², R³, R⁴, R⁵ independently are a branched or unbranched, cyclic or acyclic, substituted or unsubstituted, saturated or unsaturated C₁-C₁₀₀ hydrocarbyl group.

17-18. (canceled)
